(19) United States
(12) Patent Application Publication
(10) Pub. No.: US 2023/0122634 A1
(43) Pub. Date: Apr. 20, 2023

(54) TECHNIQUES FOR COMMUNICATING USER EQUIPMENT CAPABILITY INFORMATION

(71) Applicant: QUALCOMM Incorporated, San Diego, CA (US)

(72) Inventors: Toru UCHINO, Zushi-shi (JP); Umesh PHUYAL, San Diego, CA (US); Bharat SHRESTHA, San Diego, CA (US); Xiao Feng WANG, San Diego, CA (US); Alberto RICO ALVARINO, San Diego, CA (US)

(21) Appl. No.: 18/047,077

(22) Filed: Oct. 17, 2022

Related U.S. Application Data
(60) Provisional application No. 63/257,925, filed on Oct. 20, 2021.

(51) Int. Cl. H04W 8/24; H04B 7/185

(52) U.S. Cl. CPC H04W 8/24; H04B 7/18513

(57) ABSTRACT

Certain aspects of the present disclosure provide techniques for communicating user equipment (UE) capability information in wireless communication networks. An exemplary method performed by a UE includes receiving, from a network entity, a request for capability of the UE and transmitting, in response to the request, a UE capability message that differentiates sets of features the UE supports in different network types.

### CROSS-REFERENCE TO RELATED APPLICATIONS

This application claims benefit of and priority to U.S. Provisional Application No. 63/257,925, filed Oct. 20, 2021, which is hereby assigned to the assignee hereof and hereby expressly incorporated by reference herein in its entirety as if fully set forth below and for all applicable purposes.

### INTRODUCTION

Aspects of the present disclosure relate to wireless communications, and more particularly, to techniques for communicating user equipment (UE) capability information in wireless communication networks.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by a user equipment (UE). The method includes receiving, from a network entity, a request for capability of the UE and transmitting, in response to the request, a UE capability message that differentiates sets of features the UE supports in different network types.

Another aspect provides a method for wireless communication by a network entity. The method includes transmitting, to a user equipment (UE), a request for capability of the UE and receiving, in response to the request, a UE capability message that differentiates sets of features the UE supports in different network types.

Another aspect provides a method for wireless communication by a user equipment (UE). The method includes generating a partial set of UE capability information and transmitting the partial set of UE capability information to a network entity.

Another aspect provides a method for wireless communication by a network entity. The method includes transmitting a request for a partial set of user equipment (UE) capability information from a UE and receiving the partial set of UE capability information from the UE.

Another aspect provides a method for wireless communication by a network entity. The method includes obtaining a partial set of user equipment (UE) capability information associated with a UE and transmitting, to the UE, a request for an additional set of UE capability information.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A, 3B, 3C, and 3D depict various example aspects of data structures for a wireless communication network.

FIG. 4 illustrates an example of a wireless communications network including a non-terrestrial network (NTN) entity.

FIGS. 5A and 5B depict example architectures of an NTN.

FIG. 6 is a call flow diagram illustrating example operations for communicating user equipment (UE) capability information related to terrestrial networks (TNs) and NTNs.

FIG. 7 illustrates a first structure for a UE capability message.

FIGS. 8A, 8B, 8C, and 8D illustrate variants of the first structure for the UE capability message.

FIG. 9 illustrates a second structure for the UE capability message.

FIG. 10 provides another illustration of the second structure for the UE capability message.

FIG. 11 illustrates a third structure for the UE capability message.

FIG. 12 illustrates a carrier aggregation/dual connectivity configuration for communication by a user equipment.

FIG. 13 illustrates a fourth structure for the UE capability message.

FIG. 14 illustrates a fifth structure for the UE capability message.

FIG. 15 illustrates a sixth structure for the UE capability message.

FIGS. 16A, 16B, and 16C illustrate different manners for implicitly indicating support for orbit types in the UE capability message.

FIGS. 17A, 17B, 17C, and 17D illustrates different manners for indicating, within the UE capability message, frequency bands supported in TNs and NTNs.

FIG. 18 is a flow diagram illustrating example operations for wireless communication by a UE.

FIG. 19 is a flow diagram illustrating example operations for wireless communication by a network entity.

FIG. 20 is a flow diagram illustrating example operations for wireless communication by a UE.

FIG. 21 is a flow diagram illustrating example operations for wireless communication by a network entity, such a source base station (BS).

FIG. 22 is a flow diagram illustrating example operations for wireless communication by a network entity, such as a target BS.

FIG. 23 depicts aspects of an example communications device.

FIG. 24 depicts aspects of an example communications device.

### DETAILED DESCRIPTION

Aspects of the present disclosure provide apparatuses, methods, processing systems, and computer-readable mediums for communicating user equipment (UE) capability information, indicating support for sets of features in terrestrial networks (TNs) and non-terrestrial networks (NTNs). In some cases, more specifically, aspects of the present disclosure provide structures for communicating UE capability information. In some cases, the UE capability information may differentiate between features supported by the UE for different orbit types. In some cases, the UE capability information may differentiate between features supported by the UE for carrier aggregation and dual connectivity. Additionally, aspects of the present disclosure provide techniques for reducing an amount of information that needs to be signaled within a UE capability information. For example, in some cases, aspects of the present disclosure provide techniques for signaling a partial set of UE capability information.

### Introduction to Wireless Communication Networks

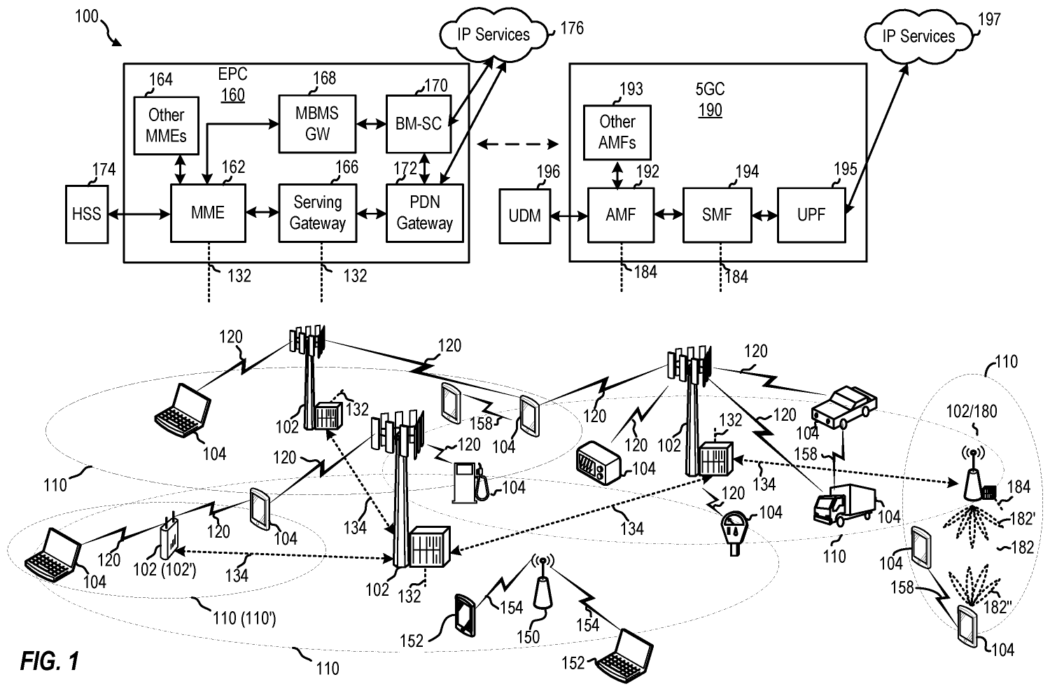

FIG. 1 depicts an example of a wireless communication network 100, in which aspects described herein may be implemented.

Generally, wireless communication network 100 includes various network entities (alternatively, network elements or network nodes), which are generally logical entities associated with, for example, a communication device and/or a communication function associated with a communication device. For example, various functions of a network as well as various devices associated with and interacting with a network may be considered network entities.

In the depicted example, wireless communication network 100 includes base stations (BSs) 102, user equipments (UEs) 104, and one or more core networks, such as an Evolved Packet Core (EPC) 160 and 5G Core (5GC) network 190, which interoperate to provide communications services over various communications links, including wired and wireless links.

BSs 102 wirelessly communicate with UEs 104 via communications links 120. The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

In various aspects, a network entity or network node can be implemented as an aggregated base station, as a disaggregated base station, an integrated access and backhaul (IAB) node, a relay node, a sidelink node, to name a few examples.

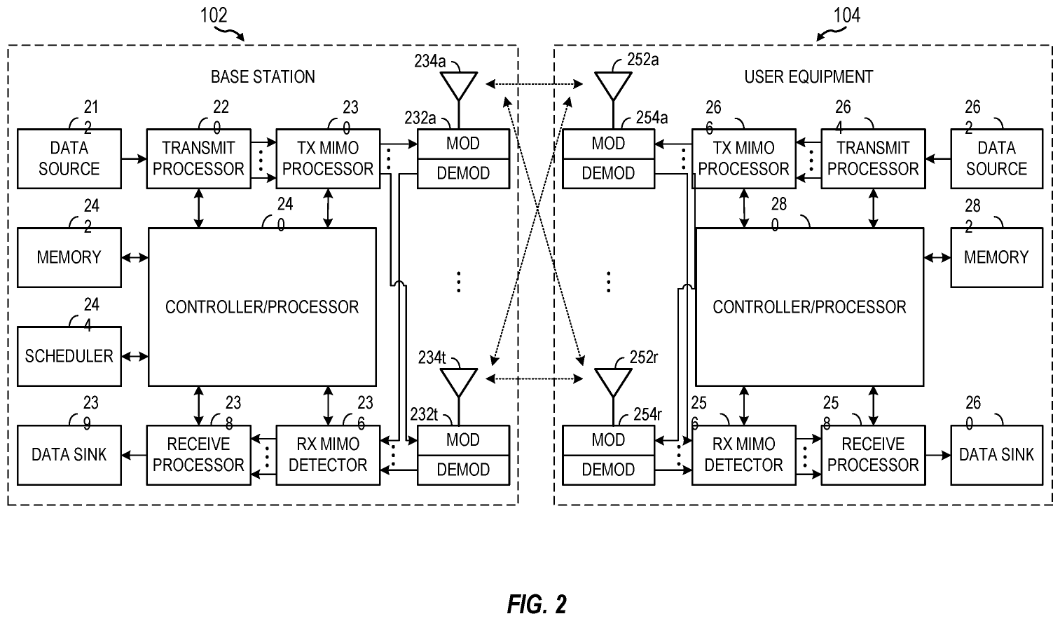

FIG. 2 depicts aspects of an example BS 102 and a UE 104.

Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104. BS 102 includes controller/processor 240, which may be configured to implement various functions described herein related to wireless communications.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260). UE 104 includes controller/processor 280, which may be configured to implement various functions described herein related to wireless communications.

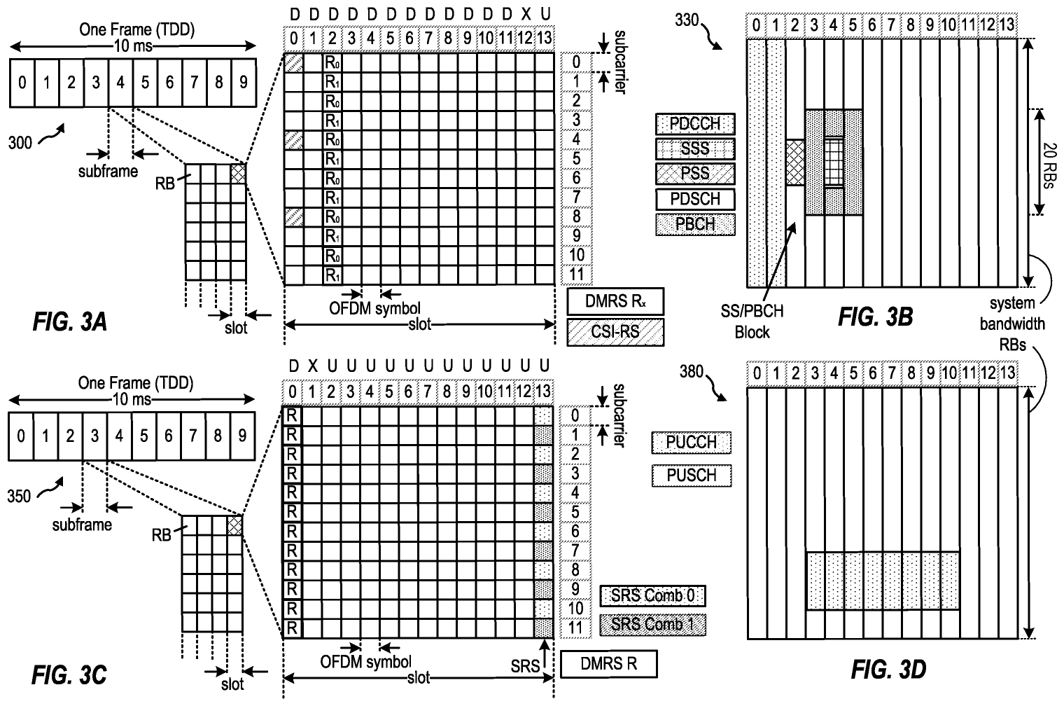

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A, 3B, 3C, and 3D are provided later in this disclosure.

### Aspects Related to Non-Terrestrial Network

A non-terrestrial network (NTN) generally refers to a network, or segment of networks using RF resources on board a satellite. NTN signaling could be regenerative (with on-board NTN processing) or transparent (e.g., so called bent pipe where the satellite sends back to Earth what it receives with only amplification and a shift from uplink to downlink frequency).

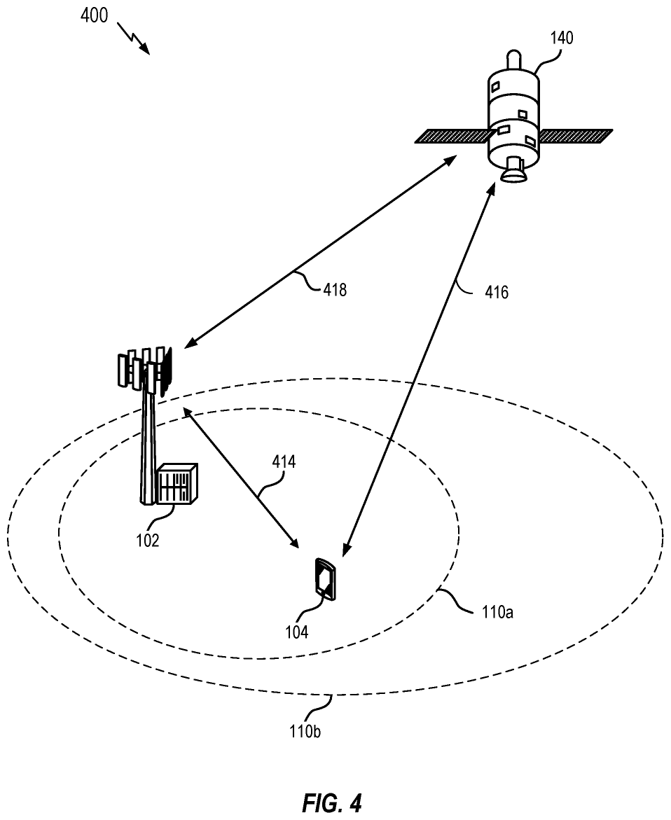

FIG. 4 illustrates an example of a wireless communications network 400 including a non-terrestrial network (NTN) entity 140 (which may be generally referred to as NTN entity 140), in which aspects of the present disclosure may be practiced. In some examples, the wireless communications network 400 may implement aspects of the wireless communication network 100. For example, the wireless communications network 400 may include BS 102, UE 104, and the NTN entity 140, such as a satellite. BS 102 may serve a coverage area or cell 110a in cases of a terrestrial network, and non-terrestrial network (NTN) entity 140 may serve the coverage area 110b in cases of an NTN. Some NTNs may employ airborne platforms (e.g., a drone or balloon) and/or spaceborne platforms (e.g., a satellite).

The NTN entity 140 may communicate with the BS 102 and UE 104 as part of wireless communications in an NTN. In cases of a terrestrial network, the UE 104 may communicate with the BS 102 over a communication link 414. In the case of NTN wireless communications, the NTN entity 140 may be a serving cell for the UE 104 via a communication link 416. In certain aspects, the NTN entity 140 may act as a relay (or a remote radio head) for the BS 102 and the UE 104. For example, the BS 102 may communicate with the NTN entity 140 via a communication link 418, and the non-terrestrial network entity may relay signaling between the BS 102 and UE 104 via the communication links 416, 418.

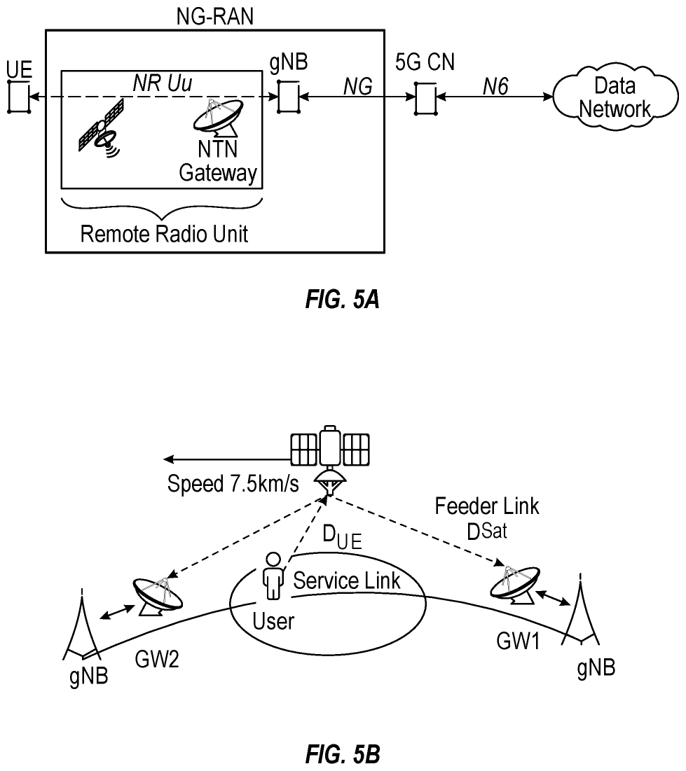

Typical footprint size of an NTN beam is 100 to 1000 km for a LEO satellite and 200 to 3500 km for a Geostationary orbit (GEO) satellite. As illustrated in FIG. 5A, an NG-RAN deployment may include satellite and NTN gateway (GW) serving as the cellular Uu) link between a UE and a terrestrial network (TN) gNB (and the 5G core network). NG-RAN generally represents radio access network for 5G and provides both NR and LTE radio access. The link between the UE and satellite is generally referred to as the service link, while the link between the satellite and GW is generally referred to as the feeder link.

As illustrated in FIG. 5B, the satellite communicates with different gateways as it moves across its orbit. In the illustrated example, as the satellite orbits (at a speed of 7.5 km/s), it moves from GW1 to GW2. Uplink signals from the UE experience a round trip delay (RTD) that is generally a sum of the delay on the service link (DUE) plus the delay on the feeder link (DSAT). The maximum RTD is typically around 541.46 ms for GEO satellites, 25.77 ms for LEO satellites at 600 km altitude, and 41.77 ms for LEO satellites at 1200 km altitude. UE speed can typically be ignored in comparison with speed of LEO satellite.

### Aspects Related to Communicating UE Capability Information

In some cases, a UE may communicate simultaneously with both a terrestrial network (TN) and a non-terrestrial network (NTN). Further, in some cases, the UE may be handed over between the TN and NTN or vice versa. As such, the UE may support different features or capabilities for communicating with the TN and NTN. For example, the UE may support a first set of capabilities in the TN and a second set of capabilities in the NTN. In some cases, capabilities in the TN may also be applicable to the NTN. The UE may indicate these capabilities to a base station (e.g., BS 102) and, in response, receive configuration information configuring the UE to use one or more of these capabilities when communicating with the base station.

Fifth generation (5G) new radio (NR)NTNs are developed with an assumption that any legacy NR feature (e.g., TN features), if needed, can be supported in an NTN. However, not all legacy UE TN features may be applicable to an NTN. Accordingly, capability differentiation between TN and NTN may be needed to indicate which features are supported by the UE in a TN and which features are supported by the UE in an NTN.

Further, in some cases, when communicating in an NTN, certain features may depend on satellite orbit types. For example, certain frequency bands may be allocated to geostationary or geosynchronous orbit (GSO) types and to non-GSO (NGSO) types. However, different UE capabilities/features may be needed for a GSO type as compared to a NGSO type. For example, a UE capability/feature may be considered mandatory in NGSO but not in GSO. As such, capability differentiation between different orbit types may be needed to indicate which features are supported by the UE in the different orbit types.

Accordingly, aspects of the present disclosure provide techniques for indicating UE capability information for communicating in TNs and NTNs. For example, such techniques may include transmitting a UE capability message that differentiates sets of features the UE supports in different network types. In some cases, the techniques presented herein provide different structures for transmitting the UE capability message.

### Example Call Flows Illustrating Operations for Communicating UE Capability Information

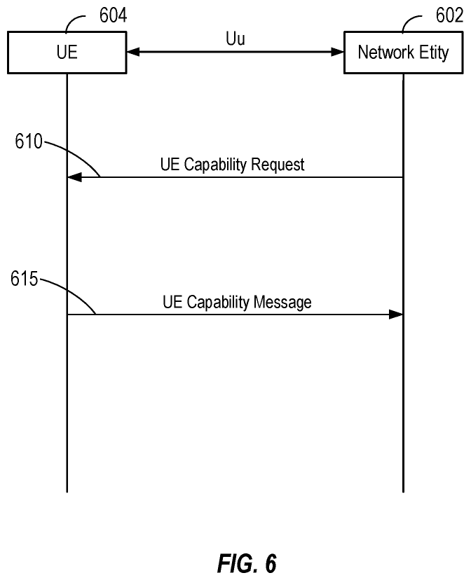

FIG. 6 is a call flow diagram illustrating example operations 600 for communicating UE capability information related to TNs and NTNs. As shown, the operations 600 may be performed by a network entity 602 and a UE 604 In some cases, the network entity 602 may be an example of the BS 102 illustrated in FIGS. 1 and 2 or the NTN entity 140 illustrated in FIG. 4. Additionally, in some cases, the UE 604 may be an example of the UE 104 illustrated in FIGS. 1, 2, and 4.

As shown, operations 600 begin at 610 with the UE 604 receiving a request for capability of the UE from the network entity 602. Thereafter, as illustrated at 615, the UE 604 transmits, in response to the request, a UE capability message that differentiates sets of features the UE supports in different network types, such as TNs and NTNs. In some cases, the features relate to at least one of: physical layer processing, medium access control layer processing, packet data convergence protocol (PDCP) processing, radio link control (RLC) processing, mobility, or IP Multimedia Subsystem (IMS).

In some cases, there may be a need to differentiate UE capabilities between TN and NTN for the same features. For example, in some cases, even for a same feature, the UE 604 may support this feature for TNs but not NTNs or vice-versa. Additionally, in some cases, indication of UE capability may depend on availably of interne of things (IoT) opportunities and, as such, techniques to allow the UE 605 to differently indicate UE capability between TN and NTN, even for the same features, may be needed. Accordingly, in some cases, NTN may be defined or treated as a separate RAT (e.g., nr-ntn) from NR TN. When the requesting NTN-related capability from the UE 604, the network entity 602 may indicate nr-ntn in a RAT type field of the request (e.g., a UE capability enquiry) received by the UE 604 at 610. Different RAT types may also be indicated within the request, such as nr, eutra-nr, eutra, utra-fdd-v1610, etc.

Accordingly, when the UE 604 receives a request that includes an indication of an NTN RAT type, the UE capability message transmitted at 615 differentiates a first set of features the UE supports in TNs from a second set of features the UE supports in NTN. In some cases, the first set of features supported in the TN and second set of features supported in the NTN may be differentiated in the UE capality message using different structures.

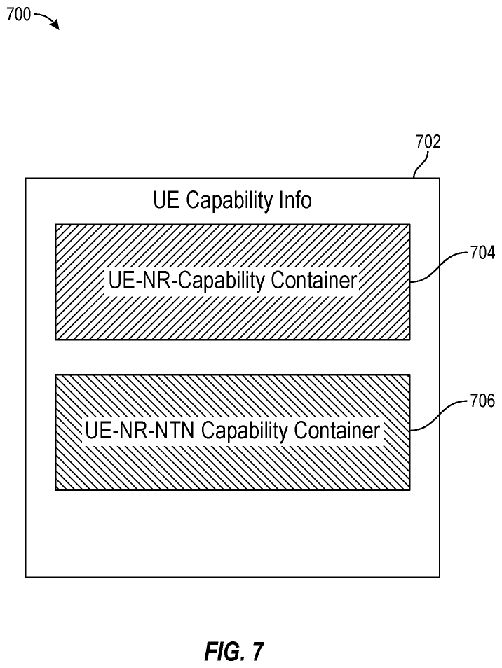

A first structure 700 for a UE capability message 702 is illustrated in FIG. 7. The UE capability message 702 may be an example of the UE capability message transmitted at 615 by the UE 604 in FIG. 6. As illustrated, the UE capability message 702 comprises a first container 704 indicating the first set of features the UE 604 supports in TNs. Additionally, as illustrated, the UE capability message 702 comprises one or more second containers 706 indicating the second set of features the UE 604 supports in NTNs.

In some cases, a structure of the one or more second container 706 for the NTN features that the UE 604 supports may be the same or similar to a structure of the first container 704 for the TN features that the UE 604 supports. In other words, the one or more second containers 706 for NTN features may reuse the structure of the first container 704 for TN features. For example, the first container 704 and second container 706 may indicate common features. In other words, the one or more second containers 706 may include fields or information elements (IEs) for the same features as the first container 704. In this case, for the TN features that are not applicable to NTN, the UE 604 may indicate a UE capability for these features as not supported.

In other cases, the structure of the one or more second containers 706 may be different from the structure of the first container 704. For example, in this case, for TN features that are not applicable to an NTN RAT type, the one or more second containers 706 may not have fields or IEs for these inapplicable features. That is, while the first container 704 for TN may include fields or IEs for these features, the one or more second containers 706 may not include fields or IEs for these features.

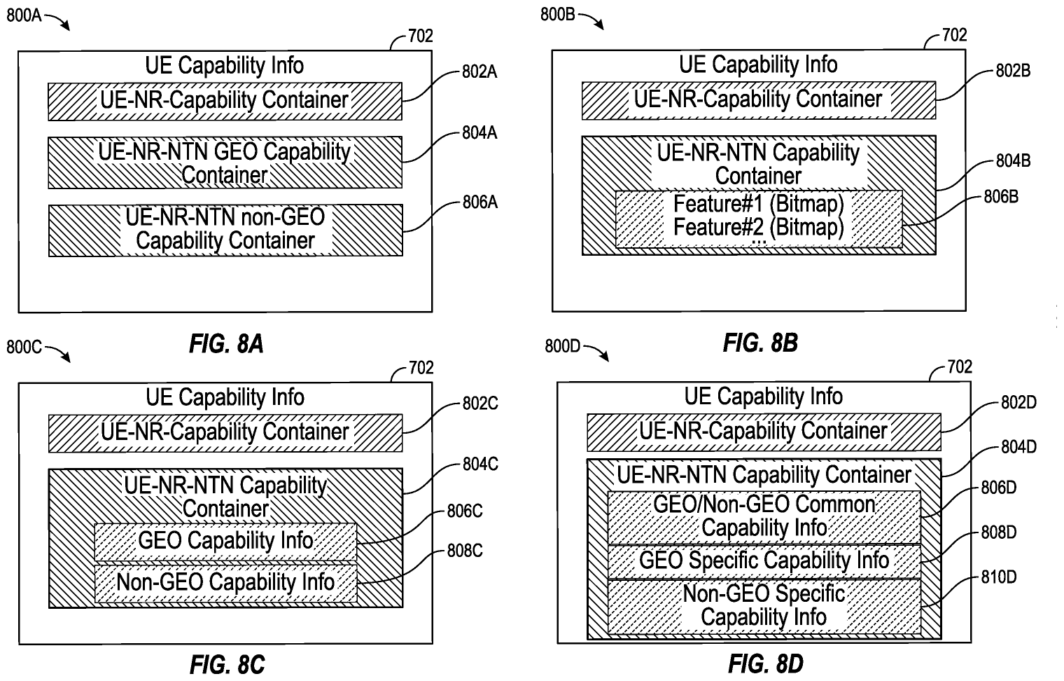

In some cases, the UE capability message transmitted by the UE 604 at 615 may differentiate sets of features the UE 604 supports in NTNs with different orbit types. In some cases, when there are orbit-specific UE features or capabilities, several variants of the first structure 700 illustrated in FIG. 7 may be considered to differentiate features that the UE 604 supports for different orbit types. For example, FIGS. 8A, 8B, 8C, and 8D illustrate different variant structures of the first structure 700 for differentiating UE support of NTN features for NTNs with different orbit types. In some cases, the different orbit types may include two or more of a low earth orbit (LEO) orbit type, a medium earth orbit (MEO) orbit type, a highly elliptical orbit (HEO) orbit type, a geostationary (GEO) orbit type, a non-GEO orbit type, a geosynchronous orbit type (GSO), non-GSO orbit type, or a high-altitude platform station (HAPS) orbit type. The example variant structures shown in FIGS. 8A, 8B, 8C, and 8D assume GEO and non-GEO orbit types, but other orbit types may also be supported by the variant structures shown in these figures.

FIG. 8A illustrates a first variant structure 800A for the UE capability message 702 transmitted at 615 in FIG. 6 by the UE 604, for example, in which the one or more second containers 706 of FIG. 7 include separate containers. More specifically, as shown in FIG. 8A, the UE capability message 702 comprises separate containers for NTN features with different orbit types. For example, as shown in FIG. 8A, the UE capability message 702 includes a TN container 802A for indicating one or more TN features that the UE 604 supports. Additionally, the UE capability message 702 illustrated in FIG. 8 includes a first NTN container 804A for indicating features that the UE 604 supports for a first orbit type (e.g., the GEO orbit type) and a second NTN container 806A for indicating features that the UE 604 supports for a second orbit type (e.g., the non-GEO orbit type).

FIG. 8B illustrates a second variant structure 800B for the UE capability message 702, for example, in which the one or more second containers 706 of FIG. 7 comprise one common container. More specifically, in the example shown in FIG. 8B, the UE capability message 702 comprises a common container that differentiates sets of features the UE 604 supports in NTNs with different orbit types. For example, as shown, the UE capability message 702 illustrated in FIG. 8B includes a TN container 802B for indicating one or more TN features that the UE 604 supports. Additionally, the UE capability message 702 illustrated in FIG. 8B includes a common NTN container 804B for indicating NTN features associated with different orbit types that the UE 604 supports. In other words, the common NTN container 804B may be used to indicate features that the UE 604 supports for the first orbit type (e.g., the GEO orbit type) and features that the UE 604 supports for the second orbit type (e.g., the non-GEO orbit type).

In the example illustrated in FIG. 8B, separate bitmaps may be used within the common NTN container 804B to indicate different features supported in NTNs of different orbit types. For example, in some cases, each bitmap may include a plurality of bits, each different bit corresponding to a different orbit type and indicating whether a particular feature is supported for the corresponding orbit type.

As an example, assume that the common NTN container 804B includes at least a first bitmap 806B for a first NTN feature that includes the following bits: 11000. In this example, the first bit may correspond to the GEO orbit type, the second bit may correspond to the MEO orbit type, the third bit may correspond to the LEO orbit type, the fourth bit may correspond to the HEO orbit type, and the fifth bit may correspond to the non-GEO orbit type. In this case, the first bitmap for the first feature may indicate that the UE 604 supports the first feature for the GEO and MEO orbit types (e.g., bit value of “1”) and indicates that the UE 604 does not support the first feature for the LEO, HEO, or non-GEO orbit types (e.g., bit value of “0”). Alternatively, a bit value of “0” may indicate the UE 604 supports the corresponding orbit type while the bit value of “1” indicates the UE 604 does not support the corresponding orbit type.

FIG. 8C illustrates a third variant structure 800C for the UE capability message 702, for example, in which the one or more second containers 706 of FIG. 7 comprise one common container. More specifically, as with FIG. 8B, the UE capability message 702 illustrated in FIG. 8C comprises a common container that differentiates sets of features the UE 604 supports in NTNs with different orbit types. However, in FIG. 8C, instead of differentiating features supported for the different orbit types using a bitmaps, the common container may include separate capability fields for the different orbit types. For example, as shown, the UE capability message 702 illustrated in FIG. 8C includes a TN container 802C for indicating one or more TN features that the UE 604 supports. Additionally, the UE capability message 702 illustrated in FIG. 8C includes a common NTN container 804C for indicating NTN features associated with different orbit types that the UE 604 supports.

Additionally, as illustrated, the common NTN container 804C may include a plurality of separate fields to differentiate NTN features for the different orbit types. For example, as shown, the common NTN container 804C may include a first NTN feature field 806C and a second NTN feature field 808C. In some cases, the first NTN feature field 806C may include capability information indicating that the UE 604 supports a first feature for the first orbit type (e.g., the GEO orbit type) and the second NTN feature field 808C may include capability information indicating that the UE 604 supports a second feature for the second orbit type (e.g., the non-GEO orbit type).

FIG. 8D illustrates a fourth variant structure 800D for the UE capability message 702, for example, in which the one or more second containers 706 of FIG. 7 comprise one common container. More specifically, as with FIGS. 8B and 8C, the UE capability message 702 illustrated in FIG. 8D includes a common container that differentiates sets of features the UE 604 supports in NTNs with different orbit types. However, in the example illustrated in FIG. 8D, the common container further includes a common feature field for indicating a common set of NTN features that are supported for different orbit types as well as a plurality of orbit-type-specific fields for indicating sets of NTN features specific to a particular orbit type. In other words, the UE capability message 702 illustrated in FIG. 8D includes a combination of at least one structure (e.g., field) indicating a common set of features supported in different orbit types and separate structures (e.g., fields) indicating different features supported in NTNs of different orbit types.

For example, as shown, the UE capability message 702 illustrated in FIG. 8D includes a TN container 802D for indicating one or more TN features that the UE 604 supports. Additionally, the UE capability message 702 illustrated in FIG. 8D includes a common NTN container 804D for indicating NTN features associated with different orbit types that the UE 604 supports. Additionally, as illustrated, the common NTN container 804D includes a common feature field 806D for indicating NTN features that the UE 604 supports that are common to both the first orbit type (e.g., the GEO orbit type) and the second orbit type (e.g., the non-GEO orbit type). Additionally, as shown, the common NTN container 804D includes a first orbit-type-specific field 808D for indicating features that the UE 604 specifically supports for the first orbit type (e.g., the GEO orbit type) and a second orbit-type-specific field 810D for indicating features that the UE 604 specifically supports for the second orbit type (e.g., the non-GEO orbit type).

In some cases, one of the variant structures 800A, 800B, 800C, or 800D may be used to differentiate, for NTNs with different orbit types, support by the UE 604 for features related to at least one of: physical layer processing, medium access control (MAC) layer processing, Packet Data Convergence Protocol (PDCP) processing, radio link control (RLC) processing, mobility, IP Multimedia Subsystem (IMS). For example, physical layer processing related features may include a modulation scheme (e.g., higher modulation scheme may not be supported for certain orbit types), a hybrid automatic repeat request (HARQ) related featured (e.g., number of HARQ processes, a HARQ round trip time, HARQ feedback, such as disabling HARQ feedback or DCI format support), a processing time (e.g., short processing time may not be supported for certain orbit types), multiple input multiple output or beam related features (e.g., spatial relation related features, channel state information related feature, higher number of layer, sounding reference signal (SRS) switching, beam failure recovery (BFR), or parameters such as beamSwitchTiming and beamReportingTiming), extended cyclic prefix (CP) related features, semi persistent signaling (SPS) (e.g., configured grant type1/2), and/or DCI based bandwidth part BWP switching.

In some cases, the PDCP related features may include, for example, a sequence number (SN) length (e.g., longer SNs may be required for certain orbit types, such as the GEO orbit type, due to longer transmission latencies) as well as extended timers (e.g., t-PollRetransmit, t-StatusReport, t-reassembly, PDCP discard timer, etc., which may be longer for certain orbit types, such as the GEO orbit type).

In some cases, the features related to mobility may include one or more inter-RAT handover (HO) features. Additionally, in some cases, the IMS related features may include one or more features related to voice over NR (VoNR). In some cases, the features layer include other features related to high-speed parameters.

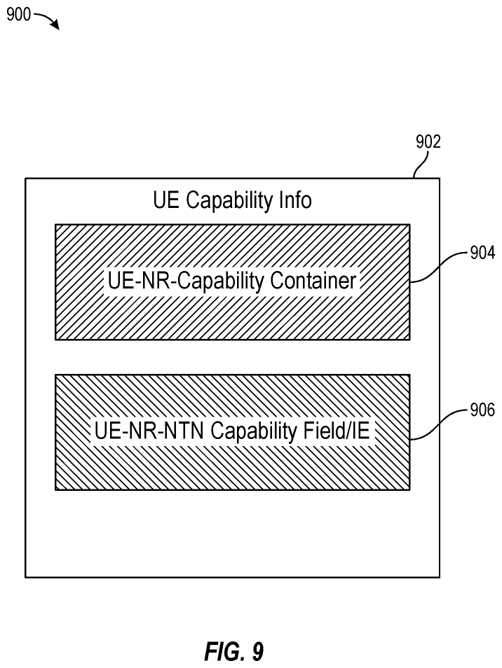

A second structure 900 for a UE capability message 902 is illustrated in FIG. 9. The UE capability message 902 may be an example of the UE capability message transmitted at 615 by the UE 604 in FIG. 6. In contrast to the first structure 700 for the capability message illustrated in FIG. 7 that includes separate containers for TN and NTN features, the second structure for the UE capability message 902 illustrated in FIG. 9 includes a common container 904 that indicates the first set of features the UE 604 supports in TNs and the second set of features the UE 604 supports in NTNs. In this case, the second set of features that the UE 604 supports in NTNs may be defined as an extension of the first set of features the UE 604 supports in TNs. For example, in addition to including the first set of features supported in TNs (e.g., UE capabilities in legacy NR), the common container 904 includes an extension 906 that includes fields or IEs indicating the second set of features supported in NTNs (e.g., UE capabilities in NR NTN).

In some cases, a structure of the extension 906 may be the same or similar to a structure of a portion of the common container 904 that carries the first set of features supported in TNs. For example, this portion of the common container 904 may be similar to that of a legacy NR RAT capability container that would normally carry the first set of features supported in TNs, such as the first container 704 illustrated in FIG. 7. In other words, the extension 906 for NTN features may reuse the structure of the portion of the common container 904 that for the TN features (e.g., similar to the first container 704 in FIG. 7 for TN features). In this case, for the TN features that are not applicable to NTN, the UE 604 may indicate a UE capability for these features as not supported.

In other cases, the structure of the extension 906 may be different from the structure of the portion of the common container 904 for the TN features. For example, in this case, for TN features that are not applicable to an NTN RAT type, the extension 906 may not have fields or IEs for these inapplicable features. That is, while the common container includes fields or IEs to indicate support for these features in TNs, the extension 906 may not include fields or IEs for these features.

In some cases, as noted above, the UE capability message transmitted by the UE 604 at 615 may differentiate sets of features the UE 604 supports in NTNs with different orbit types. In this case, variant structures similar to those illustrated in FIGS. 8A, 8B, 8C, and 8D may be applied to the second structure 900 and used for the UE capability message 902 illustrated in FIG. 9.

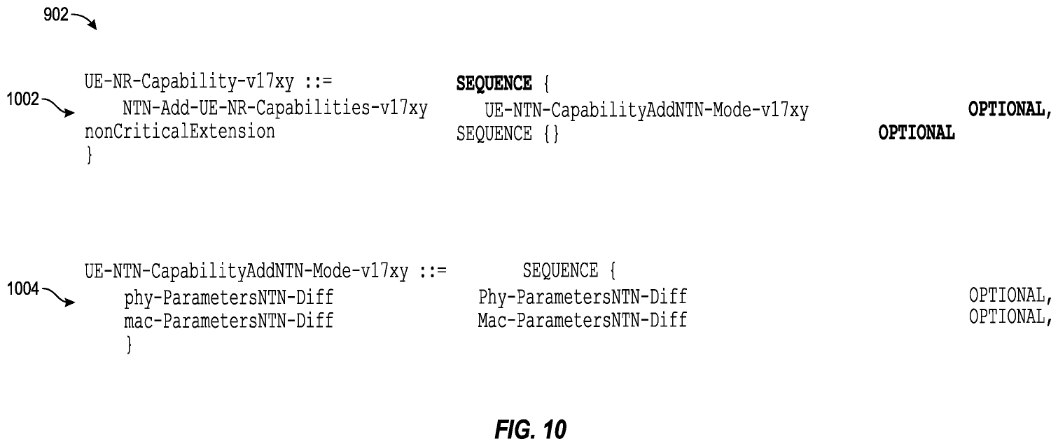

In other cases, a legacy NR container for indicating UE capability may apply to TN and NTN by default. However, if orbit type specific (e.g., NTN specific) capability needs to be signaled differently, then an extension of the legacy NR container to differentiate these orbit type specific capabilities may be added. In this case, a common set of features may be included within the common container 904 that apply to both TNs and NTNs networks by default. Additionally, the extension 906 may be used to differentiate features supported in only one of TNs or NTNs. For example, as illustrated in FIG. 10, the UE capability message 902 includes a common container 1002 that includes a common set of features that apply to both TNs and NTNs networks by default. Further, the UE capability message 902 includes an extension 1004 that differentiates features supported in only one of TNs or NTNs. In other words, if a first feature is supported in TNs but not in NTNs, the extension 1004 may indicate that this feature is not supported in NTN. Otherwise, if a second feature is supported in both TNs and in NTNs, this feature may be included within the common container 1002 and it may be understood that the second feature is supported for both TNs and NTNs. In other words, because the second feature is supported in both TNs and NTNs, it does not need to be separately indicated for both TNs and NTNs.

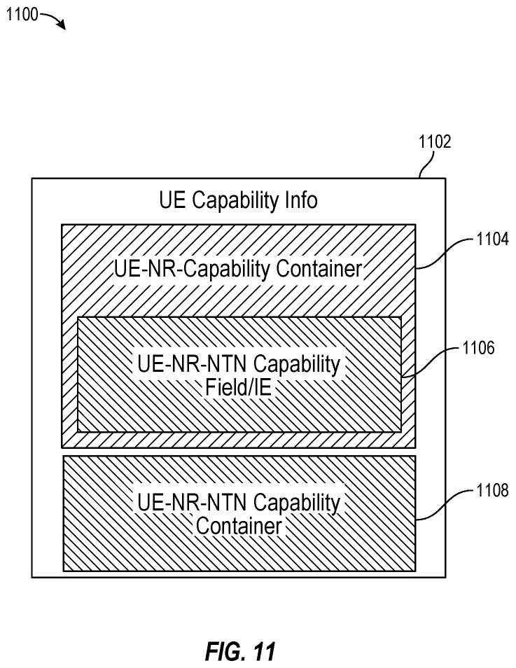

A third structure 1100 for a UE capability message 1102 is illustrated in FIG. 11. The UE capability message 1102 may be an example of the UE capability message transmitted at 615 by the UE 604 in FIG. 6. As shown, the third structure 1000 is a combination of the first structure 700 and the second structure 900. For example, like the second structure 900 illustrated in FIG. 9, the UE capability message 1102 in the third structure 1100 includes a common container 1104 that indicates the first set of features the UE 604 supports in TNs and at least a portion of the second set of features the UE 604 supports in NTNs. In some cases, the common container 1104 may comprise a legacy NR RAT capability container that includes an extension 1106 (e.g., one or more fields/IEs) for indicating the portion of the second set of features the UE 604 supports in NTNs. Further, similar to the first structure 700 illustrated in FIG. 7, the UE capability message 1102 includes a second container 1108 for indicating features the UE 604 supports for NTNs. More specifically, the second container 1108 may indicate a second portion of the second set of features the UE supports in NTNs.

In some cases, when using the third structure 1100 for the UE capability message 1102, the network entity may indicate “nr” and “nr-ntn” in a RAT type field of the request (e.g., a UE capability enquiry) received by the UE 604 at 610. Further, when using the third structure 1100 for the UE capability message 1102, support for features in NTNs may be grouped into two groups and indicated in corresponding containers (e.g., the common container 1104 or the second container 1108. In some cases, when indicating support for orbit specific features/capabilities, variant structures similar to those illustrated in FIGS. 8A, 8B, 8C, and 8D may be applied to the third structure 1100 and used for the UE capability message 1102 illustrated in FIG. 11.

In some cases, NTN features may be grouped in different manners. For example, in some cases, common TN and NTN features may be grouped into a first group and included within the common container 1104. In other words, the common TN and NTN features represent the first set of features the UE 604 supports in TNs and at least a portion of the second set of features the UE 604 supports in NTNs indicated within the common container 1104. Further, NTN features which are not common between TNs and NTNs may be grouped in a second group and included in the second container 1108. In other words, the non-common NTN features represent the second portion of the second set of features the UE supports in NTNs.

In other cases, NTN features for which the legacy NR RAT UE capability structure already supports a sufficient granularity (e.g., per band or per band combination capability granularity) may be grouped into a first group while NTN features for which the legacy NR RAT UE capability structure does not support a sufficient granularity (e.g., per UE capability granularity). In this case, NTN features for which the legacy NR RAT UE capability structure already supports the sufficient granularity may be included within the common container 1104 while NTN features for which the legacy NR RAT UE capability structure does not support the sufficient granularity may be included in the second container 1108.

In some cases, the second container is limited to differential UE capability compared to common container 1104. More specifically, the second container 1108 may be used to indicate support for the NTN features/capabilities that need to be reported differently from the TN features (e.g., not common to TNs). For example, if UE needs to report support for some feature or capability differently for NTNs, then the second container 1108 contains only those features that need to be reported differently. In some cases, additional containers may also be included within the UE capability message 1102 to indicate differential UE capability for different orbit types. For example, in some cases, the second container 1108 may be used to indicate differential UE capability for the GEO orbit type while a third container may be used to indicate differential UE capability for the non-GEO orbit type. In some cases, these techniques may reduce the size of the second container 1108 as only differently reported features are included. Any newly introduced NTN specific capabilities or features may be added to common container 1104 within the extension 1106. In some cases, an indication may also be added in common container 1104 whether or not UE needs to report certain NTN features or capabilities differently.

### Aspects Related to Signaling TN-NTN Carrier Aggregation and Dual Connectivity Capabilities

In some cases, carrier aggregation (CA) and dual connectivity (DC) may be used by the UE 604 to communicate with a network, such as a TN or an NTN. For example, in some cases, the UE may use CA/DC to communicate with a TN base station (e.g., BS 102) using one or more TN carriers and with an NTN base station (e.g., NTN entity 140) using one or more NTN carriers. The one or more TN carriers and one or more NTN carriers may be within certain respective TN- and NTN-specific frequency bands. In other cases, the UE may use CA/DC to communicate with two different NTN base stations (e.g., two different NTN entities 140). In some cases, while CA/DC communication may be facilitated, from the perspective of the UE 604, via two different base stations, from the perspective of the network, the CA/DC communication may be controlled or operated by only one network entity.

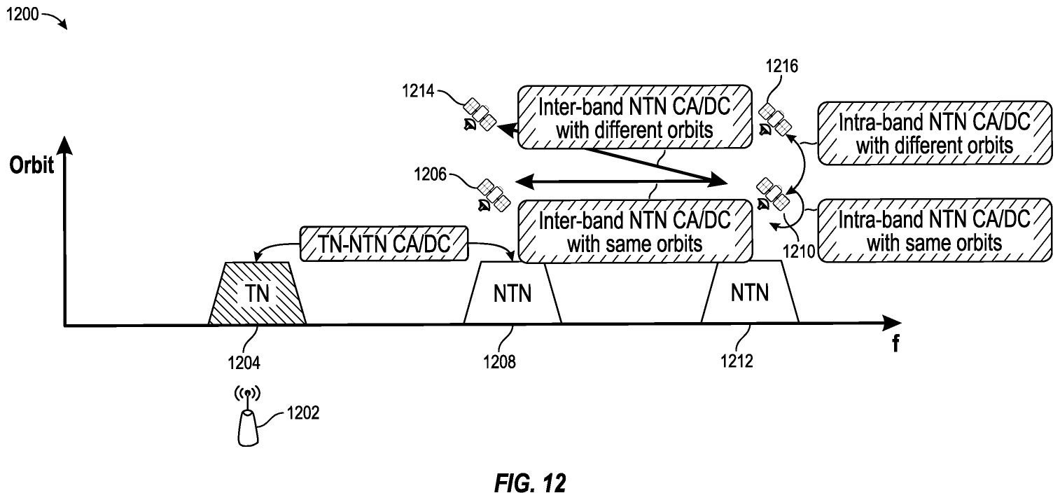

FIG. 12 illustrates a CA/DC configuration for communication by a UE, such as the UE 604. As shown, in some cases, the UE may use CA/DC to communicate with a TN base station 1202 using a TN carrier 1204 as well as with a first NTN base station 1206 using a first NTN carrier 1208. In some cases, the first NTN base station may be associated with a first orbit type (e.g., GEO, LEO, or MEO).

In other cases, the UE may communicate using CA/DC with two different NTN base stations, which may be associated with different orbit types. Further, in some cases, such CA/DC communication may be inter-band or intra-band. For example, as illustrated, the UE may in some cases use CA/DC to communicate with the first NTN base station 1206 using the first NTN carrier 1208 and to communicate with a second NTN base station 1210 using a second NTN carrier 1212, known as inter-band NTN CA/DC. Further, as shown, the first NTN base station 1206 and the second NTN base station 1210 may be of the same orbit type and, as such, this type of CA/DC may be further known as intra-orbit CA/DC.

Additionally, in other cases, the UE may use CA/DC to communicate with a third NTN base station 1214 using the first NTN carrier 1208 and to communicate with the second NTN base station 1210 using the second NTN carrier 1212. Again, this may be known as inter-band NTN CA/DC. In this example, however, the second NTN base station 1210 and the third NTN base station 1214 may be of different orbit types. As such, this type of CA/DC may be further known as inter-orbit CA/DC.

In other cases, the UE may use CA/DC to communicate with the second NTN base station 1210 using the second NTN carrier 1212 and to communicate with a fourth NTN base station 1216 also using the second NTN carrier 1212. This may be known as intra-band NTN CA/DC. Additionally, in this example, the second NTN base station 1210 and the fourth NTN base station 1216 may be of the same orbit type.

In some cases, when using TN-NTN CA/DC for communication, additional UE capability information may need to be signaled, such as support for one or more TN-NTN band combinations (e.g., combinations of TN and NTN frequency bands that the UE supports for communicating with the TN and NTN using CA/DC). Accordingly, aspects of the present disclosure provide techniques for signaling this additional UE capability information within the UE capability message transmitted at 615 in FIG. 6 by the UE 604

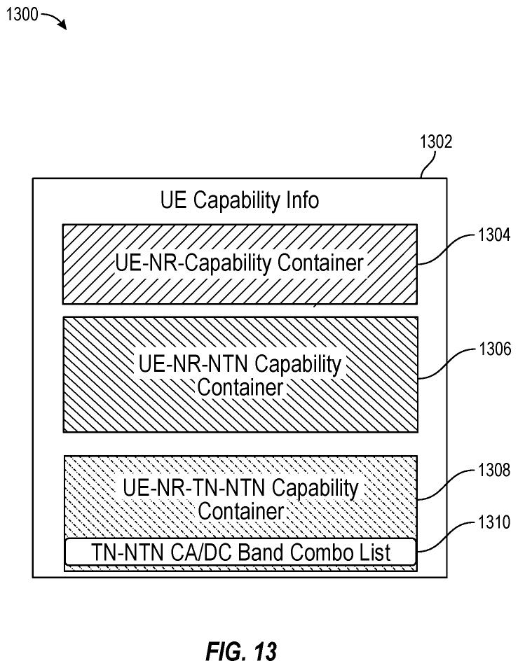

For example, in some cases, an E-UTRA-NR dual connectivity (EN-DC) approach or a NR-E-UTRA dual connectivity (NE-DC) approach may be used when UE-NR TN-NTN capability needs to signaled, as illustrated in FIG. 13. For example, FIG. 13 illustrates a fourth structure 1300 for transmitting a UE capability message to indicate support of TN-NTN related features/capabilities. As shown, FIG. 13 includes a UE capability message 1302, which may be an example of the UE capability message transmitted at 615 by the UE 604 in FIG. 6.

Further, similar to that of the EN-DC and NE-DC cases, the UE capability message 1302 includes a first container 1304 for indicating a first set of features the UE 604 supports in TNs (e.g., a UE-NR container for legacy NR features). Additionally, as illustrated, the UE capability message 1302 includes a second container 1306 indicating a second set of features the UE 604 supports in NTNs (e.g., a UE-NR-NTN container for standalone NTN features). Additionally, the UE capability message 1302 includes a third container 1308 including a set of TN and NTN features for TN-NTN CA/DC (e.g., a UE-NR-TN-NTN container for TN-NTN CA/DC features). For example, as illustrated, the third container 1308 may include a set of TN and NTN band combinations 1310 in which the UE 604 supports at least one of carrier aggregation or dual connectivity.

In some cases, when orbit-specific RATs are defined (e.g., GEO, non-GEO, etc.), requiring the UE 604 to indicate support for features/capabilites associated with different NTN orbit types, the third container 1308 may include a different set of TN and NTN band combinations for each NTN orbit type. The UE may indicate support for the features/capabilities associated with the different NTN orbit types in separate containers. For example, in some cases, the third container 1308 may be associated with a first orbit type (e.g., the GEO orbit type) and used to indicate a set of TN and NTN band combinations for the first orbit type. Additionally, the UE capability message 1302 may include at least one other container associated with a second orbit type (e.g., the non-GEO orbit type) and used to indicate another set of TN and NTN band combinations for the second orbit type. In other words, TN-NTN CA/DC features supported by the UE for different orbit types may be included within separate containers (e.g., separate UE-NR-TN-NTN containers).

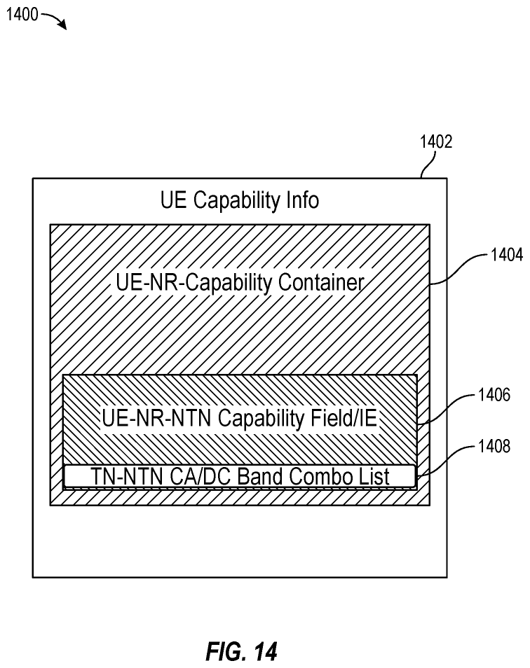

FIG. 14 illustrates a fifth structure 1400 that may be used for transmitting a UE capability message 1402 to indicate support of TN-NTN CA/DC related features/capabilities. In some cases, the UE capability message 1402 may be an example of the UE capability message transmitted at 615 by the UE 604 in FIG. 6. Further, in some cases, the fifth structure 1400 for the UE capability message 1402 may be similar to a structure used for NR-CA/DC. For example, as illustrated, the UE capability message 1402 includes a first container 1404 for indicating a first set of features the UE 604 supports in TNs (e.g., a UE-NR container for legacy NR features). Additionally, the first container 1404 may be extended to include a portion 1406 (e.g., one or more fields or IEs) indicating a second set of features supported in NTNs (e.g., UE capabilities in NR NTN). Further, as illustrated, the portion 1406 may include a set of TN and NTN band combinations 1408 in which the UE 604 supports at least one of carrier aggregation or dual connectivity.

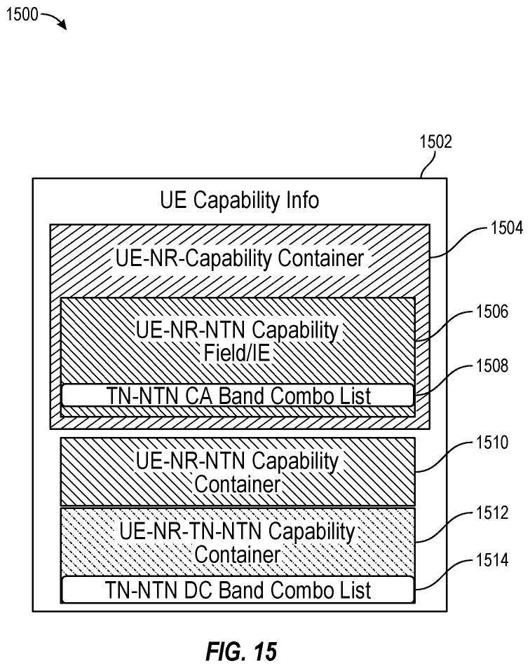

FIG. 15 illustrates a sixth structure 1500 that may be used for transmitting a UE capability message 1502 to indicate support of TN-NTN CA/DC related features/capabilities. In some cases, the UE capability message 1502 may be an example of the UE capability message transmitted at 615 by the UE 604 in FIG. 6. As shown, the sixth structure 1500 for the UE capability message 1502 represents a combination of the fourth structure 1300 illustrated in FIG. 13 and the fifth structure 1400 illustrated in FIG. 14. In the example shown in FIG. 15, the UE 604 may indicate support for TN-NTN dual connectivity and carrier aggregation features (e.g., sets of band combinations supported for carrier aggregation and dual connectivity) in separate containers.

For example, as illustrated, the UE capability message 1502 includes a first container 1504 for indicating a first set of features the UE 604 supports in TNs (e.g., a UE-NR container for legacy NR features). Additionally, the first container 1504 may be extended to include a portion 1506 (e.g., one or more fields or IEs) indicating a second set of features supported in NTNs (e.g., UE capabilities in NR NTN). Further, as illustrated, the portion 1506 may include a set of TN and NTN band combinations 1508 in which the UE 604 supports carrier aggregation. As shown, the UE capability message 1502 also includes a second container 1510 indicating a second set of features the UE 604 supports in NTNs (e.g., a UE-NR-NTN container for standalone NTN features).

Additionally, as shown, the UE capability message 1502 includes a third container 1512 including a set of TN and NTN features for TN-NTN DC (e.g., a UE-NR-TN-NTN container for TN-NTN DC features). For example, as illustrated, the third container 1512 includes a set of TN and NTN band combinations 1514 in which the UE 604 supports dual connectivity.

### Additional Details Regarding Indicating Sets of Features Supported in NTNs with Different Orbit Types

As noted above, in some cases, the UE capability message transmitted by the UE 604 at 615 may differentiate sets of features the UE 604 supports in NTNs with different orbit types. In some cases, the UE 604 may differentiate a set of features for the GEO orbit type from a set of features for the non-GEO orbit type, for example, using one of the variant structures illustrated in FIGS. 8A-8D. In other cases, the differentiation of sets of features for orbit types may be more granular. For example, in some cases, the UE 604 may differentiate sets of features in the UE capability message for the LEO orbit type, the MEO orbit type, the HEO orbit type, and/or the GEO orbit type.

In some cases, orbit types may be characterized in terms of an elevation. For example, orbits within a range of elevations X and Y may be considered a first orbit type, while orbits within a rand between Y and Z may be considered a second orbit type, and so on. More specifically orbital elevations between 300 km and 36000 km with a granularity of, for example, 2 km may be defined as several different orbit types.

Further, in some cases, communication characteristics, such as a latency level (one-way or round trip time) and environment change (e.g., radio quality change due to satellite movement), may be considered when differentiating sets of features that the UE 604 supports since the UE 604 may not be aware of the orbit types but may be aware of the communication characteristics associated with the orbit types. More specifically, for example, latency levels between 20 ms and 600 ms with a granularity of 20 ms may be defined as several different orbit types

In some cases, in addition to indicating sets of features that the UE 604 supports for different orbit types, the UE 604 may also indicate whether the UE 604 supports these different orbit types to begin with. The UE 604 may indicate support for orbit types in different manners, such as via implicit indication, explicit indication, or a combination thereof.

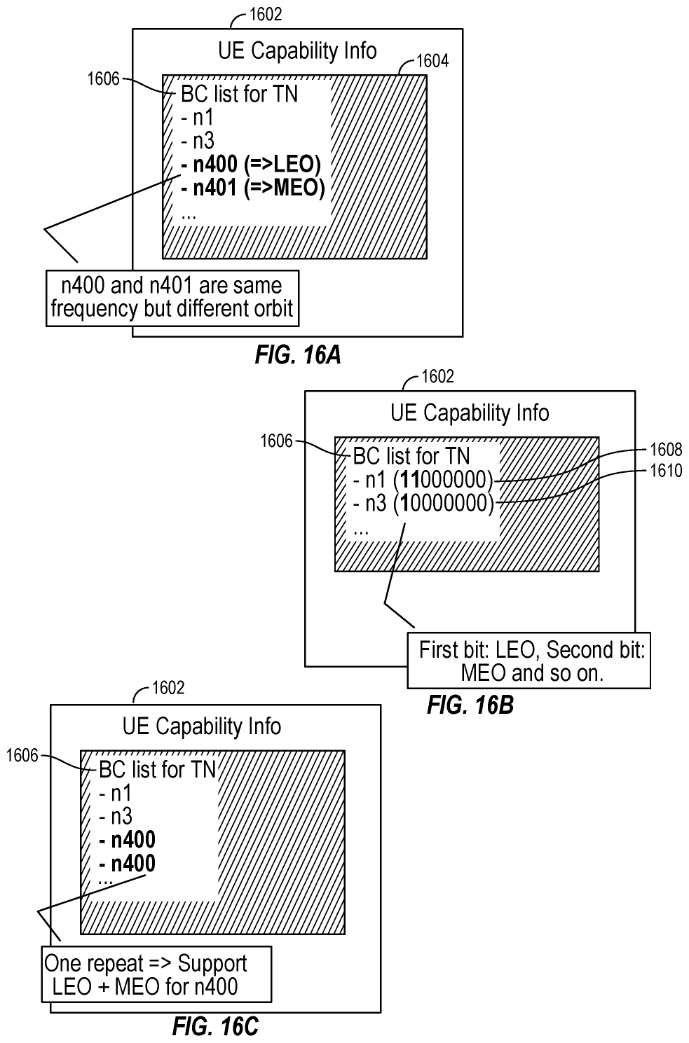

In some cases, the UE may implicitly indicate support for the orbit types in different manners, as illustrated in FIGS. 16A, 16B, and 16C. In some cases, the different manners of indicating support for the orbit types may be applicable to the second structure 900 illustrated in FIG. 9 for the capability message transmitted at 615 in FIG. 6 and the third structure 1100 illustrated in FIG. 11 for the capability message transmitted at 615.

FIG. 16A illustrates a first manner for implicitly indicating support for orbit types in a UE capability message 1602. In some cases, the UE capability message 1602 comprises the UE capability message transmitted at 615 by the UE 604 and incorporates the second structure 900 illustrated in FIG. 9. For example, the UE capability message 1602 includes a common container 1604 (e.g., similar to the common container 904 illustrated in FIG. 9) that includes a common set of features that apply to both TNs and NTNs networks by default as well as an extension that includes fields or IEs indicating a second set of features supported in NTNs (e.g., UE capabilities in NR NTN).

Additionally, as illustrated, the common container 1604 includes a band combination list 1606. The band combination list 1606 includes a set of frequency bands that the UE 604 supports in TNs and NTNs. For example, as shown, the band combination list 1606 indicates that the UE 604 supports frequency bands n1 and n3 in TNs and frequency bands n400 and n401 in NTNs. In some cases, the frequency bands n400 and n401 may comprise a same physical frequency band, but may be used to differentiate whether the UE 604 supports this physical frequency band for different NTN orbit types. For example, in some cases, an indication of the frequency band n400 in the band combination list 1606 may implicitly indicate that the UE 604 supports the physical frequency band for the LEO orbit type while an indication of the frequency band n401 may implicitly indicate that the UE 604 supports the physical frequency band for the MEO orbit type.

FIG. 16B illustrates a second manner for implicitly indicating support for orbit types in the UE capability message 1602. As shown, the second manner for implicitly indicating support for orbit types involves a band combination set IE defined per orbit type. In some cases, the band combination set may include sets of bits associated with each frequency band indicated in the band combination list 1606. For example, as illustrated, the frequency band n1 is associated with a first set of bits 1608 in the band combination list 1606 and the frequency band n3 is associated with a second set of bits 1610 in the band combination list 1606.

The first set of bits 1608 includes a first set of bits for indicating support by the UE 604 of the frequency band n1 for different orbit types. For example, in some cases, when a first bit of the first set of bits 1608 is set to a value of “1”, this may indicate that the UE 604 supports the frequency band n1 for the LEO orbit type. Additionally, when a second bit of the first set of bits 1608 is set to a value of “1”, this may indicate that the UE 604 supports the frequency band n1 for the MEO orbit type. Each remaining bit of the first set of bits 1608 may indicate whether the UE 604 supports the frequency band n1 for remaining orbit types (e.g., HEO, GEO, non-GEO, etc.). In some cases, rather than a value of “1”, a value of “0” in the first set of bits 1608 may indicate that the UE 604 supports the n1 band for a corresponding orbit type.

Similarly, the second set of bits 1610 includes a second set of bits for indicating support by the UE 604 of the frequency band n3 for the different orbit types. For example, in some cases, when a first bit of the second set of bits 1610 is set to a value of “1”, this may indicate that the UE 604 supports the frequency band n3 for the LEO orbit type. However, when a second bit of the second set of bits 1610 is set to a value of “0”, this may indicate that the UE 604 does not support the frequency band n3 for the MEO orbit type. Each remaining bit of the second set of bits 1610 may indicate whether the UE 604 supports the frequency band n3 for remaining orbit types (e.g., HEO, GEO, non-GEO, etc.). In some cases, rather than a value of “1”, a value of “0” in the second set of bits 1610 may indicate that the UE 604 supports the n3 band for a corresponding orbit type.

FIG. 16C illustrates a third manner for implicitly indicating support for orbit types in the UE capability message 1602. As shown, the third manner for implicitly indicating support for orbit types involves repeating a same frequency band or band number in the band combination list 1606. For example, as illustrated, the frequency band n400 may be repeated twice in the band combination list 1606. In some cases, each repetition of a frequency band n400 may indicate support for a different orbit type. For example, when the band combination list 1606 does not include any repetitions of the frequency band n400, this may indicate that the UE supports the frequency band n400 for the LEO orbit type. Further, when the band combination list 1606 includes one repetition of the frequency band n400, as shown in FIG. 16C, this may indicate that the UE 604 supports the frequency band n400 for the LEO orbit type and the MEO orbit type. Additional repetitions, such as two repetitions of the frequency band n400, may indicate that the UE 604 supports the frequency band n400 for the LEO orbit type, the MEO orbit type, and the GEO orbit type, and so on.

As noted above, in some cases, the UE 604 may indicate support for different orbit types explicitly. For example, the UE 604 may provide a different explicit indication within the UE capability message transmitted at 615, indicating which orbit types that the UE 604 supports. In some cases, the explicit indications may be indicated per frequency band in a band combination list. For example, in some cases, the UE 604 may provide a first explicit indication that the UE 604 supports the frequency band n400 for the LEO orbit type and may also provide a second explicit indication that the UE 604 does not support the frequency band n400 for the MEO orbit type. In some cases, the explicit indications indication may use common names for the orbit types, such as LEO, MEO, GEO, etc.

In some cases, rather than explicitly indicating the different orbit types that the UE 604 supports, the UE 604 may instead indicate different orbital elevations that may be supported by the UE 604. The different orbital elevations may each be associated with a range and granularity (e.g., orbital elevations between 300 km and 36000 km with a granularity of 2 km). As such, the UE 604 may indicate which elevations within the range that the UE 604 may support.

Whether the UE 604 implicitly or explicitly indicates the orbit types that are supported, the UE 604 may either indicate each orbit type that the UE 604 supports or may indicate a highest orbit type supported by the UE 604. In some cases, when a highest orbit type supported by the UE 604 is indicated, this may imply that lower orbit types are also supported by the UE 604.

### Additional Details Regarding Indicating Frequency Bands Supported in NTNs

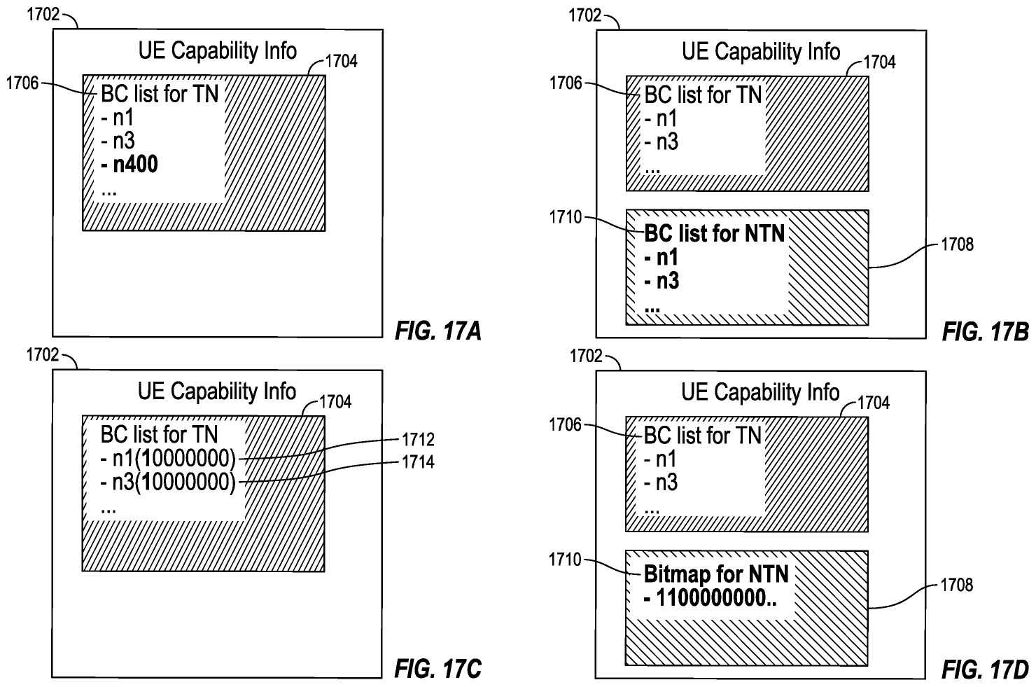

As noted above, in some cases, the UE capability message transmitted at 615 by the UE 604 may indicate a first set of features the UE 604 supports in TNs and a second set of features the UE 604 supports in NTNs. In some cases, the first set of features may include frequency bands supported by the UE 604 in TNs and the second set of features may include frequency bands supported by the UE 604 in NTNs. In some cases, the frequency bands supported by the UE 604 may be indicated within one or more band combination lists in the UE capability message. FIGS. 17A, 17B, 17C, and 17D illustrate different manners for indicating frequency bands supported by the UE 604 in TNs and NTNs.

FIG. 17A illustrates a first manner for indicating, within a UE capability message 1702, frequency bands supported by the UE 604 in TNs and NTNs. In some cases, the UE capability message 1702 comprises the UE capability message transmitted at 615 by the UE 604 and incorporates the second structure 900 illustrated in FIG. 9. For example, the UE capability message 1702 includes a first container 1704 (e.g., similar to the common container 904 illustrated in FIG. 9) that includes a common set of features that apply to both TNs and NTNs networks by default as well as an extension that includes fields or IEs indicating a second set of features supported in NTNs (e.g., UE capabilities in NR NTN).

Additionally, as illustrated, the first container 1704 includes a first band combination list 1706. The first band combination list 1706 includes a set of frequency bands that the UE 604 supports in TNs and NTNs. In some cases, to differentiate the frequency bands supported by the UE 604 in NTNs from the frequency bands supported by the UE 604 in TNs within the first band combination list 1706, the UE 604 may use NTN specific band definitions for the frequency bands supported by the UE 604 in NTNs. For example, as illustrated in FIG. 17A, the UE 604 may indicate include frequency bands n1 and n3 within the first band combination list 1706 indicating the UE 604 supports these frequency bands in TNs. Additionally, the UE 604 may incidate an NTN specific frequency band, such as n400, to indicate that the UE 604 supports the frequency band n400 in NTNs.

FIG. 17B illustrates a second manner for manner for indicating, within the UE capability message 1702, frequency bands supported by the UE 604 in TNs and NTNs. As shown, the second manner for indicating the supported frequency bands involves the use of separate band combination lists for TN and NTN. For example, as shown in FIG. 17B, the UE capability message 1702 has a structure similar to the first structure 700 illustrated in FIG. 7, including a first container 1704 indicating a first set of features the UE 604 supports in TNs and a second container 1708 indicating a second set of features the UE 604 supports in NTNs.

In some cases, the first set of features may include a set of frequency bands supported by the UE 604 in TNs and may be indicated within the first band combination list 1706 included within the first container 1704. Additionally, the second set of features may include a set of frequency bands supported by the UE 604 in NTNs and may be indicated within a second band combination list 1710 included within the second container 1708. In some cases, when indicating the frequency bands that the UE 604 supports in NTNs within the second band combination list 1710, rather than indicating NTN specific frequency bands like in the first manner described above with respect to FIG. 17A, the UE 604 may instead include an indication of an existing TN frequency band and an indication of NTN support capability for that frequency band. For example, as illustrated, the UE 604 may indicate support for TN frequency bands n1 and n3 in the first band combination list 1706. Additionally, the UE 604 may also indicate frequency bands n1 and n3 within the second band combination list 1710 to indicate that the UE 604 supports these frequency bands in NTNs.

FIG. 17C illustrates a third manner for indicating, within the UE capability message 1702, frequency bands supported by the UE 604 in TNs and NTNs. As shown, a structure of the UE capability message 1702 in FIG. 17C may be the same or similar to the second structure 900 illustrated in FIG. 9. As shown, the third manner for indicating the supported frequency bands involves a band combination set IE defined per frequency band. In some cases, each band combination set IE may include a set of bits associated with a respective frequency band that may be set to indicate whether the UE 604 supports that respective frequency band in NTNs.

For example, as shown, the UE capability message 1702 includes the first container 1704 (e.g., similar to the common container 904 illustrated in FIG. 9) that includes a common set of features that apply to both TNs and NTNs networks by default as well as an extension that includes fields or IEs indicating a second set of features supported in NTNs (e.g., UE capabilities in NR NTN).

Additionally, the first container 1704 includes the first band combination list 1706. Further, as illustrated, the first band combination list 1706 includes a set of frequency bands that the UE 604 supports in TNs, such as the frequency bands n1 and n3. Each of the frequency bands n1 and n3 may be associated with a band combination set IE including sets of bits that may be used for indicating whether the UE 604 supports the frequency bands n1 and n3 in NTNs. For example, as shown, the frequency band n1 may be associated with a first band combination set IE including a first set of bits 1712 and the frequency band n3 may be associated with a second band combination IE including a second set of bits 1714. In some cases, one or more bits or the first set of bits 1712 may be set (e.g., to a bit value of “1”) to indicate that the UE 604 supports the frequency band n1 in NTNs. Similarly, one or more bits or the second set of bits 1714 may be set (e.g., to bit value of “1”) to indicate that the UE 604 supports the frequency band n3 in NTNs. In some cases, a bit value of “0”, rather than a bit value of “1”, may indicate that the UE 604 supports a corresponding frequency band in NTNs, such as frequency band n1.

FIG. 17D illustrates a fourth manner for manner for indicating, within the UE capability message 1702, frequency bands supported by the UE 604 in TNs and NTNs. As shown, the fourth manner for indicating the supported frequency bands involves the use of a band combination list to indicate supported frequency bands for TNs and a separate bitmap for indicating supported frequency bands in NTNs. For example, as shown in FIG. 17D, the UE capability message 1702 has a structure similar to the first structure 700 illustrated in FIG. 7, including the first container 1704 indicating the first set of features the UE 604 supports in TNs and the second container 1708 indicating the second set of features the UE 604 supports in NTNs.

As noted above, the first set of features may include a set of frequency bands supported by the UE 604 in TNs and may be indicated within the first band combination list 1706 included within the first container 1704. Additionally, the second set of features may include a set of frequency bands supported by the UE 604 in NTNs. However, unlike the frequency bands supported by the UE 604 in TNs, the set of frequency bands supported by the UE 604 in NTNs may be indicated in the second container 1708 using a new capability IE, such as a bitmap.

For example, as illustrated, the second container 1708 includes a bitmap 1716 comprising a plurality of bits. In some cases, each bit of the plurality of bits of the bitmap 1716 in the second container 1708 may correspond to a different frequency band indicated in the first band combination list 1706 of the first container 1704. As an example, a first bit of the bitmap 1716 may correspond to the frequency band n1 indicated in the first band combination list 1706 of the first container 1704. Similarly, a second bit of the bitmap 1716 may correspond to the frequency band n3 indicated in the first band combination list 1706 of the first container 1704. Accordingly, the UE 604 may selectively set the first bit and second bit to indicate whether the UE 604 supports the frequency bands n1 and n3 in NTNs. For example, as illustrated, the UE 604 may set the first bit and second bit to a value of “1”, indicating that the UE 604 supports the frequency bands n1 and n3 in NTNs. In some cases, rather than a bit value of “1”, a bit value of “0” may be used to indicate that the UE 604 supports the frequency bands n1 and n3 in NTNs.

### Example Methods for Communicating UE Capability Information

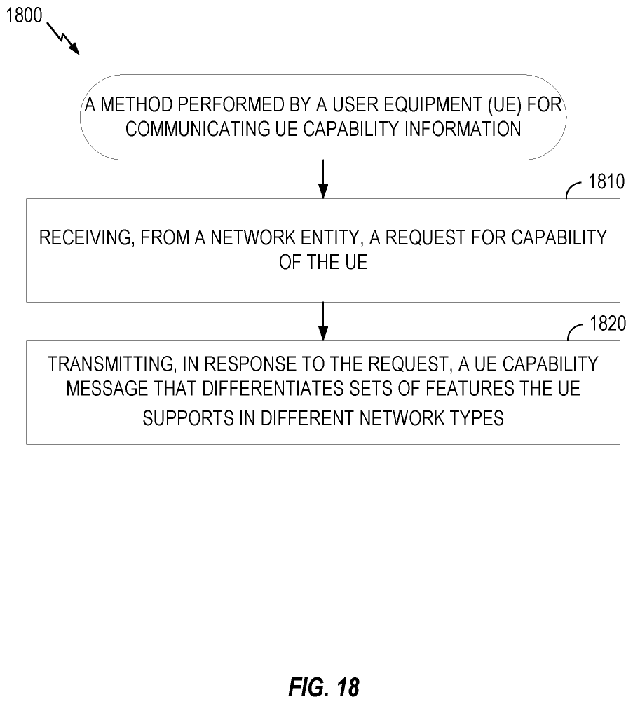

FIG. 18 shows a method 1800 for wireless communication by a UE, such as the UE 104 in the wireless communication network 100 of FIG. 1 and/or UE 604 illustrated in FIG. 6, for communicating UE capability information.

As shown, method 1800 begins at step 1810 with the UE receiving, from a network entity, a request for capability of the UE.

At step 1820, the UE transmits, in response to the request, a UE capability message that differentiates sets of features the UE supports in different network types.

In some cases, the UE capability message differentiates a first set of features the UE supports in terrestrial networks (TNs) from a second set of features the UE supports in non-terrestrial network (NTNs).

In some cases, the request includes a radio access technology (RAT) type that indicates NTNs as a separate RAT.

In some cases, the UE capability message differentiates sets of features the UE supports in NTNs with different orbit types.

In some cases, the different orbit types comprise two or more of a low earth orbit (LEO) orbit type, medium earth orbit (MEO) orbit type, highly elliptical orbit (HEO) orbit type, geostationary (GEO) orbit type, or a non-GEO orbit type.

In some cases, the UE capability message comprises: a first container indicating the first set of features the UE supports in TNs and one or more second containers indicating the second set of features the UE supports in NTNs.

In some cases, the one or more second containers comprise separate containers for NTNs with different orbit types.

In some cases, the one or more second containers comprises a common container that differentiates sets of features the UE supports in NTNs with different orbit types.

In some cases, the common container includes at least one of: separate bitmaps indicating different features supported in NTNs of different orbit types, separate capability fields for different orbit types, or a combination of at least one structure indicating a common set of features supported in different orbit types and separate structures indicating different features supported in NTNs of different orbit types.

In some cases, the one or more second containers differentiate, for NTNs with different orbit types, UE support for features related to at least one of: physical layer processing, packet data convergence protocol (PDCP) processing, radio link control (RLC) processing, mobility, or IP Multimedia Subsystem (IMS).

In some cases, the first container and the one or more second containers indicate common features, and for a feature not applicable to NTNs, the UE indicates, in the one or more second containers, that the feature is not supported.

In some cases, the UE capability message comprises a common container indicating: the first set of features the UE supports in TNs, and the second set of features the UE supports in NTNs.

In some cases, a common set of features in the common container apply to both TNs and NTNs networks by default, and the common container includes an extension that differentiates features supported in only one of TNs or NTNs.

In some cases, the UE capability message comprises: a first container indicating the first set of features the UE supports in TNs and a first portion of the second set of features the UE supports in NTNs, and at least a second container indicating a second portion of the second set of features the UE supports in NTNs.

In some cases, the second container is limited to differential UE capability compared to first container.

In some cases, the second set of features indicates a set of TN and NTN band combinations in which the UE supports at least one of carrier aggregation or dual connectivity.

In some cases, the UE capability message comprises at least one of: a container that includes TN and NTN band combination for different NTN orbit types, or one or more orbit-specific containers, each indicating TN and NTN band combinations for a corresponding NTN orbit.

In some cases, the UE capability message implicitly indicates an orbit associated with a band of a band combination via at least one of: a band defined for NTN per orbit type, a band combination set defined per orbit type, or by repeating a same band number for different orbit types.

In some cases, the UE capability message explicitly indicates an orbit associated with a band of a band combination.

In some cases, the UE capability message indicates the UE supports features in a frequency band via at least one of: NTN specific band definitions, or an indication of an existing band and NTN support capability for that band.

In some cases, the second set of features indicates a set of TN and NTN band combinations in which the UE supports carrier aggregation, the UE capability message further differentiates a third set of features the UE supports in NTN terrestrial from the second set of features the UE supports in NTNs, the third set of features indicates a set of TN and NTN band combinations in which the UE supports dual connectivity, and the second set of features and the third set of features are included in separate containers in the UE capability message.

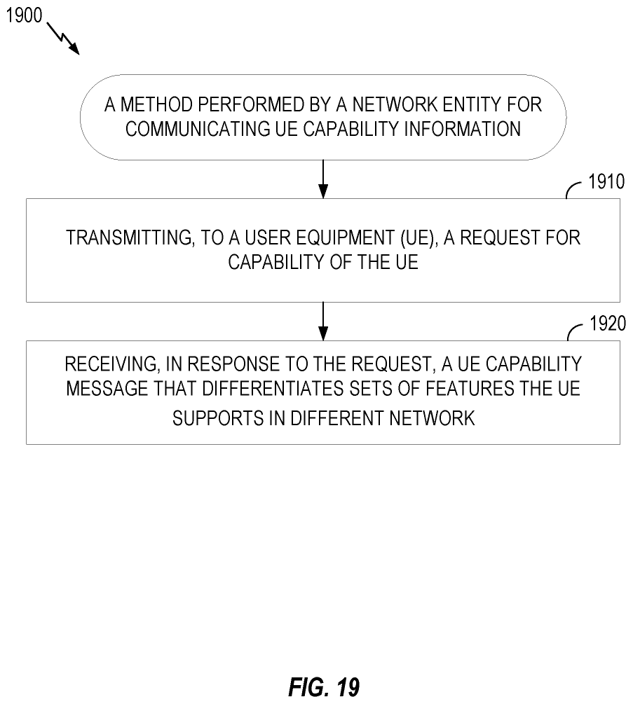

FIG. 19 shows a method 1900 for wireless communication by a network entity, such as a source BS (e.g., BS 102 of FIGS. 1 and 2 and/or NTN entity 140 of FIG. 4) for communicating UE capability information.

As shown, method 1900 begins at step 1910 with the network entity transmitting, to a user equipment (UE), a request for capability of the UE.

At step 1920 the network entity receives, in response to the request, a UE capability message that differentiates sets of features the UE supports in different network types.

In some cases, the UE capability message differentiates a first set of features the UE supports in terrestrial networks (TNs) from a second set of features the UE supports in non-terrestrial network (NTNs).

In some cases, the request includes a radio access technology (RAT) type that indicates NTNs as a separate RAT.

In some cases, the UE capability message differentiates sets of features the UE supports in NTNs with different orbit types.

In some cases, the different orbit types comprise two or more of a low earth orbit (LEO) orbit type, medium earth orbit (MEO) orbit type, highly elliptical orbit (HEO) orbit type, geostationary (GEO) orbit type, or a non-GEO orbit type.

In some cases, the UE capability message comprises: a first container indicating the first set of features the UE supports in TNs and one or more second containers indicating the second set of features the UE supports in NTNs.

In some cases, the one or more second containers comprise separate containers for NTNs with different orbit types.

In some cases, the one or more second containers comprises a common container that differentiates sets of features the UE supports in NTNs with different orbit types.

In some cases, the common container includes at least one of: separate bitmaps indicating different features supported in NTNs of different orbit types, separate capability fields for different orbit types, or a combination of at least one structure indicating a common set of features supported in different orbit types and separate structures indicating different features supported in NTNs of different orbit types.

In some cases, the one or more second containers differentiate, for NTNs with different orbit types, UE support for features related to at least one of: physical layer processing, packet data convergence protocol (PDCP) processing, radio link control (RLC) processing, mobility, or IP Multimedia Subsystem (IMS).

In some cases, the first container and one or more second containers indicate common features, and for a feature not applicable to NTNs, the UE indicates, in the one or more second containers, that the feature is not supported.

In some cases, the UE capability message comprises a common container indicating: the first set of features the UE supports in TNs, and the second set of features the UE supports in NTNs.

In some cases, a common set of features in the common container apply to both TNs and NTNs networks by default, and the common container includes an extension that differentiates features supported in only one of TNs or NTNs.

In some cases, the UE capability message comprises: a first container indicating the first set of features the UE supports in TNs and a first portion of the second set of features the UE supports in NTNs, and at least a second container indicating a second portion of the second set of features the UE supports in NTNs.

In some cases, the second container is limited to differential UE capability compared to first container.

In some cases, the second set of features indicates a set of TN and NTN band combinations in which the UE supports at least one of carrier aggregation or dual connectivity.

In some cases, the UE capability message comprises at least one of: a container that includes TN and NTN band combination for different NTN orbit types, or one or more orbit-specific containers, each indicating TN and NTN band combinations for a corresponding NTN orbit.

In some cases, the UE capability message implicitly indicates an orbit associated with a band of a band combination via at least one of: a band defined for NTN per orbit type, a band combination set defined per orbit type, or by repeating a same band number for different orbit types.

In some cases, the UE capability message explicitly indicates an orbit associated with a band of a band combination.

In some cases, the UE capability message indicates the UE supports features in a frequency band via at least one of: NTN specific band definitions, or an indication of an existing band and NTN support capability for that band.

In some cases, the second set of features indicates a set of TN and NTN band combinations in which the UE supports carrier aggregation, the UE capability message further differentiates a third set of features the UE supports in NTN terrestrial from the second set of features the UE supports in NTNs, the third set of features indicates a set of TN and NTN band combinations in which the UE supports dual connectivity, and the second set of features and the third set of features are included in separate containers in the UE capability message.

### Aspects Related to Indicating a Partial Set of UE Capability Information

In the case of a handover (HO) of a UE (e.g., UE 604) from source BS in a network to a target BS of the network, the source base station may need to know certain UE capabilities related to a target frequency and RAT associated with the target base station. For example, for NTN-to-TN handovers (e.g., in which the UE is handed over from an NTN BS to a TN BS), the NTN BS may need to know TN capabilities or features supported by the UE (e.g., supported frequency band, subcarrier spacing, bandwidth, etc.) to decide an appropriate target system, frequency, and measurement configuration. In the NTN-to-TN HO case, this implies that the NTN BS needs to transmit a request (e.g., the request received by the UE 604 at 610 in FIG. 6) for both NTN UE capability and TN UE capability from the UE via an NTN radio. Since NTN may have narrow BW (e.g., GEO), requesting both the NTN UE capability and TN capability would result in UE consuming a significant amount of time, frequency, and power resources to transmit this the NTN and TN capability information. This problem is generally applicable to any case of mobility from a BS associated with a narrow BW to BS associated with a wider BW (e.g., mobility early generation to later generation).

Accordingly, aspects of the present disclosure provide techniques to help avoid situations in which UE consumes a significant amount of time, frequency, and power resources transmitting UE capability information to a BS associated with a narrow BW. For example, in some cases, such techniques may involve only transmitting a partial set of the UE capability information, thereby limiting the amount of UE capability information that needs to be transmitted by the UE, for example, in the UE capability message transmitted at 615 in FIG. 6. Accordingly, by limiting the amount of UE capability information that needs to be transmitted, the UE may not need to expend as much time or power transmitting the UE capability information, reducing power consumption and conserving time and frequency resources within the network.

It should be noted that these techniques may be applied to any mobility scenario (e.g., NTN-to-NTN HO, TN-to-NTN HO, etc.) as well as non-mobility scenarios, such as to initial access. For example, during initial access, the network may derive only minimum set of UE capability to save radio resources or due to that the network may only support features comparable to the partial set of UE capability information. In any case, the UE capability information may be indicated in two steps, such a first step where the partial set of UE capability information is communicated and a second step where a full set of UE capability information is communicated. Additionally, it should be noted that while the source BS and the target BS may appear, from the perspective of the UE 604, as two different entities, the source BS and the target BS may be controlled or operated by a single network entity.

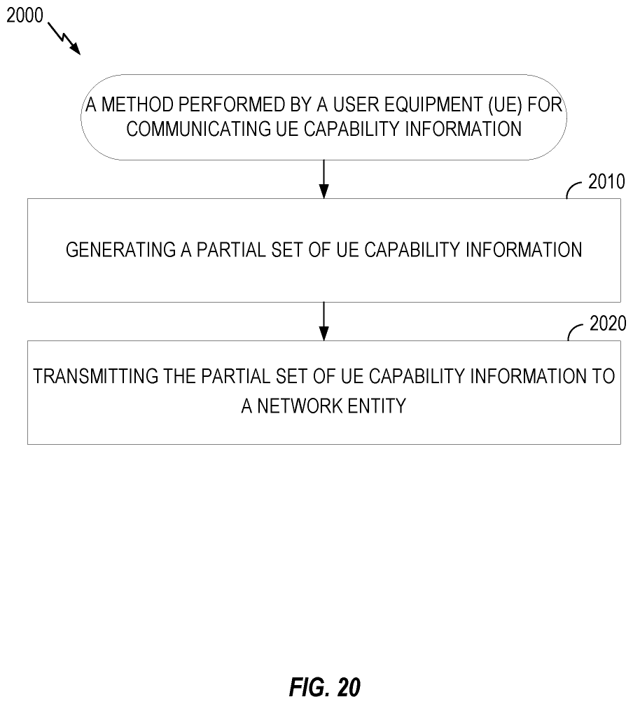

FIG. 20 shows a method 2000 for wireless communication by a UE, such as the UE 104 in the wireless communication network 100 of FIG. 1 and/or UE 604 illustrated in FIG. 6, for communicating a partial set of UE capability information.

As shown, method 2000 begins at step 2010 with the UE generating a partial set of UE capability information. In some cases, the UE capability information within the partial set of UE capability information may indicate one or more features or capabilities that the UE supports for communication in certain network (e.g., TN and/or NTN), as described above.

At step 2020, the UE transmits the partial set of UE capability information to a network entity. In some cases, the UE may transmit the partial set of UE capability in a UE capability message, such as the UE capability message transmitted at 615 by the UE 604 in FIG. 6. Accordingly, in some cases, the UE may transmit the partial set of UE capability information within the UE capability message using one or more of the structures illustrated in FIGS. 7, 8A8D, 9, 11, 13-15, 16A-16C, or 17A-17D. In such cases, the partial set of UE capability information indicates sets of features the UE supports in different network types. Additionally, in some cases, the partial set of UE capability information differentiates a first set of features the UE supports in TNs from a second set of features the UE supports in NTN.

In some cases, the partial set of UE capability information generated by the UE in block 1802 relates to mobility of the UE (e.g., a handover of the UE from a source BS to a target BS) and comprises at least one of one or more supported RATs, one or more supported core network (CN) types, one or more supported frequency bands, one or more supported SCSs, or one or more supported BWs.

In some cases, the partial set of UE capability information generated by the UE at step 2010 comprises at least one of one or more supported measurement capabilities, one or more supported mobility capabilities, one or more supported random access channel (RACH) capabilities (e.g., a 2-step RACH capability).

In some cases, the partial set of UE capability information generated by the UE in block 1802 may comprise a minimum set of UE capability information the UE is to report (e.g., supported frequency bands, SCS and BW) as well as an additional set of UE capability information (e.g., supported measurement/mobility capabilities or features)

In some cases, the UE may receive a trigger, indicating whether the UE should generate the partial set of UE capability information or a full set of UE capability information. The trigger may comprise an explicit trigger or may comprise an implicit trigger. For example, in some cases, the UE may receive, from a network entity, a request for capability of the UE that indicates explicitly the request is for the partial set of UE capability information. In some cases, the network entity may comprise a base station (e.g., BS 102 illustrated in FIGS. 1 and 2) or another UE (e.g., in the case of sidelink communication). In some cases, the request may be received in a UE capability enquiry message (such as the request received at 610 by the UE 604 in FIG. 6) or may be received in system information.

In some cases, for certain RAT network types (e.g., NTN), the UE may be configured to report the partial set of UE capability information unless a request for capability of the UE indicates the request is for a full set of UE capability information. In such cases, by not receiving a request for a full set of UE capability information, the UE may implicitly by triggered to generate the partial set of UE capability informaton in block 1802.

In cases of mobility, after the UE is handed over from a source BS to a target BS, the target BS may thereafter request the UE to transmit an additional set of UE capability information. For example, in some cases, when handing the UE over to a target BS, the source BS may generate the partial set of UE capability information and send it to the target BS. In some cases, the source BS may indicate to the target BS that the partial set of UE capability information was generated by the source BS. In some cases, the source BS may transmit at least one of the partial set of UE capability information or the indication that the partial set of UE capability information was generated by the source BS via an inter-node message or a network interface (e.g., X2 interface, Xn interface, etc.).

Thereafter, once the UE is handed over to the target BS, the target BS may request an additional set of UE capability information, for example, to supplement the partial set of UE capability information received from the source BS. In some cases, the additional set of UE capability information requested by the target BS may include UE capability information not included in the partial set of UE capability information. In other cases, the additional set of UE capability information comprises a full set of UE capability information including UE capability information included in the partial set of UE capability information.

In some cases, the target BS may request the additional (e.g., full) set of UE capability after HO is completed, which may cause unnecessary steps and lead to power consumption and wasted time and frequency resources. Accordingly, in some cases, to avoid the power consumption and wasted time and frequency resources associated with requesting the additional set of UE capability information after completion of the handover, the target BS may instead request the additional set of UE capability information during the handover.

For example, in some cases, the UE may be requested to generate the additional set of UE capability information based on a UE capability request or enquiry. In some cases, the request for the additional set of UE capability information may be included within a handover command received from the source BS or the request for the additional set of UE capability information may be multiplexed with handover command received from the source BS. In other cases, the UE may be triggered to generate and send the additional set of UE capability implicitly based on a type of handover. For example, when the type of handover comprises an NTN-to-TN handover, the UE may, by default, be triggered to generate and send the additional (e.g., full) set of UE capability information after completion of the handover. In this case, the target BS may not need to transmit a request for the additional UE capability information after completion of the handover, thereby conserving time, frequency, and power resources.

In some cases, when the request for the additional UE capability information is received during the handover, the UE may begin generating a UE capability message, including the additional UE capability information, at the time the request is received or after the handover is complete (e.g., after a random access procedure is completed with the target BS).

In some cases, the handover of the UE from the source BS to the target BS may fail for various reasons. When this occurs, the UE may initiate a radio resource control (RRC) reestablishment procedure. In such cases, the request for the additional UE capability information may be transmitted by the target BS in an RRC message, such as an RRC reestablishment message, an RRC reconfiguration message, or an RRC resume message. In some cases, rather than the target BS transmitting the request within the RRC message, the UE may be implicitly triggered to generate the additional UE capability information based on a type of cell that the target BS belongs. For example, in some cases, when a handover fails, the UE may determine that the target BS belongs to a TN cell. Accordingly, in response to determining the target BS belongs to a TN cell, the UE may be implicitly triggered to generate the additional set of UE capability information.

In some cases, for an RRCresume procedure, the request for the additional UE capability information may be transmitted within an RRCresume message.

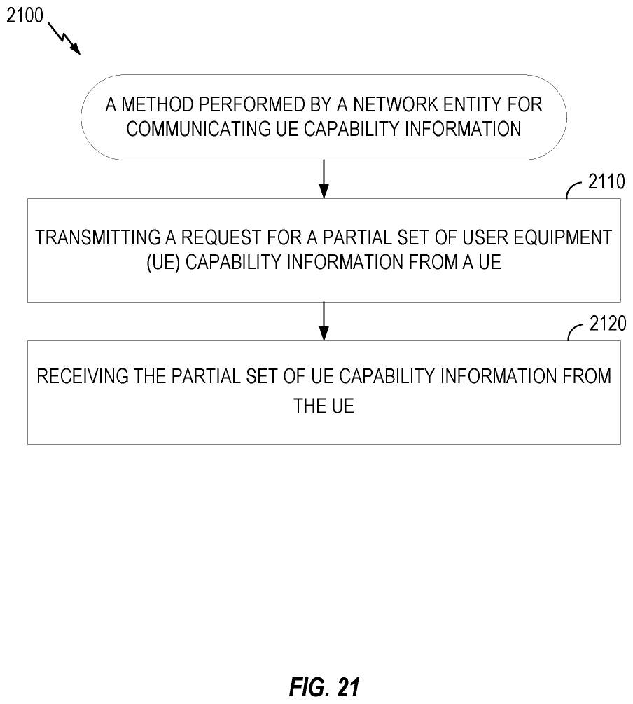

FIG. 21 shows a method 2100 for wireless communication by a network entity, such as a source BS (e.g., BS 102 of FIGS. 1 and 2 and/or NTN entity 140 of FIG. 4) for communicating a partial set of UE capability information.

As shown, method 2100 begin at step 2110 with the source BS transmitting a request for a partial set of user equipment (UE) capability information from a UE.

At step 2120, the source BS receives the partial set of UE capability information from the UE.

In some cases, the partial set of UE capability information indicates sets of features the UE supports in different network types.

In some cases, the partial set of UE capability information differentiates a first set of features the UE supports in terrestrial networks (TNs) from a second set of features the UE supports in non-terrestrial network (NTN).

In some cases, the partial set of UE capability information relates to mobility of the UE and comprises at least one of: one or more supported radio access technologies (RATs), one or more supported core network (CN) types, one or more supported frequency bands, one or more supported subcarrier spacings (SCSs), or one or more supported bandwidths (BWs).

In some cases, the partial set of UE capability information comprises at least one of: one or more supported measurement capabilities, one or more supported mobility capabilities, or one or more supported random access channel (RACH) capabilities.

In some cases, the partial set of UE capability information comprises: a minimum set of UE capability information the UE is to report and an additional set of UE capability information.

In some cases, the method 2100 further includes transmitting a handover command to the UE to hand over the UE from the network entity to another network entity and transmitting, to the UE, another request for an additional set of UE capability information.

In some cases, the other request is transmitted within the handover command or is multiplexed and transmitted with the handover command.

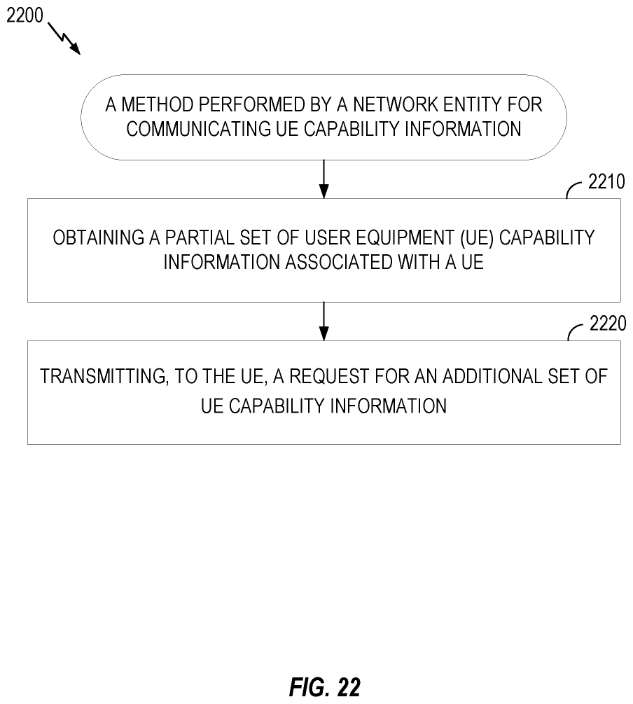

FIG. 22 shows a method 2200 for wireless communication by a network entity, such as a target BS (e.g., BS 102 of FIGS. 1 and 2 and/or NTN entity 140 of FIG. 4) for communicating a partial set of UE capability information.

As shown, method 2200 begins at step 2210 with the target BS obtaining a partial set of user equipment (UE) capability information associated with a UE.

At step 2220, the target BS transmit, to the UE, a request for an additional set of UE capability information.

In some cases, the partial set of UE capability information indicates sets of features the UE supports in different network types.

In some cases, the partial set of UE capability information differentiates a first set of features the UE supports in terrestrial networks (TNs) from a second set of features the UE supports in non-terrestrial network (NTN).

In some cases, the partial set of UE capability information relates to mobility of the UE and comprises at least one of: one or more supported radio access technologies (RATs), one or more supported core network (CN) types, one or more supported frequency bands, one or more supported subcarrier spacings (SCSs), one or more supported bandwidths (BWs).

In some cases, the partial set of UE capability information comprises at least one of: one or more supported measurement capabilities, one or more supported mobility capabilities, one or more supported random access channel (RACH) capabilities.

In some cases, the partial set of UE capability information comprises: a minimum set of UE capability information the UE is to report and an additional set of UE capability information.

In some cases, the additional set of UE capability information comprises UE capability information not included in the partial set of UE capability information.

In some cases, the additional set of UE capability information comprises a full set of UE capability information including UE capability information included in the partial set of UE capability information.

In some cases, the request for the additional set of UE capability information is transmitted in, or multiplexed with, a handover command.

In some cases, the request for the additional set of UE capability information is transmitted in a radio resource control (RRC) reestablishment message, an RRC reconfiguration message, or an RRC resume message.

In some cases, the additional set of UE capability information is received after completion of a handover associated with the UE.

In some cases, the partial set of UE capability information is received from another network entity.

### Example Wireless Communication Devices

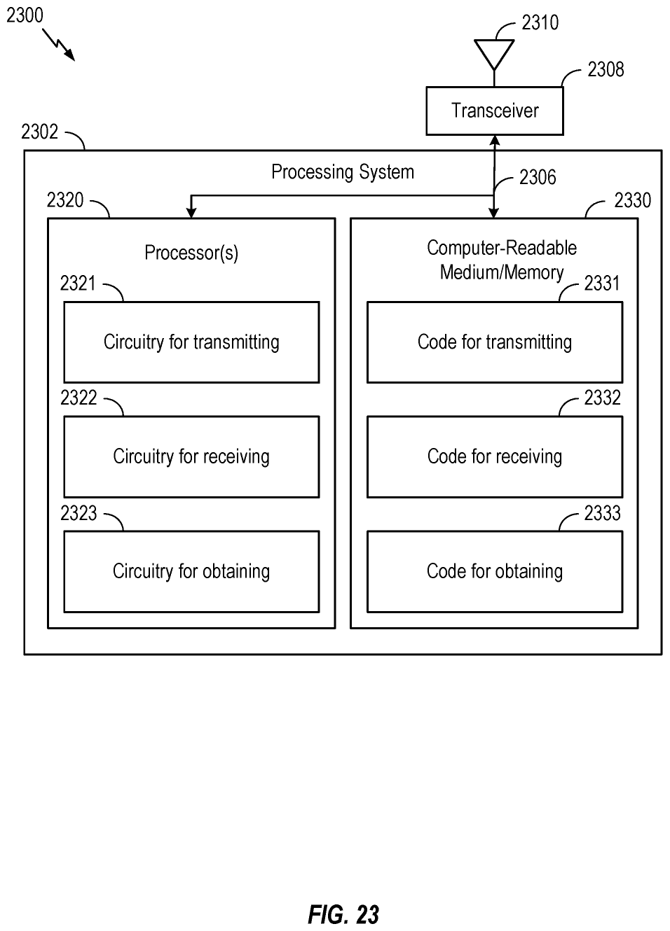

FIG. 23 depicts aspects of an example communications device. In some examples, communications device Error! Reference source not found.00 may be a network entity, such as the BS 102 as described, for example with respect to FIGS. 1 and 2 or the NTN entity 140 described with respect to FIG. 4. In some cases, the network entity may comprise a source BS while in other cases, the network entity may comprise a target BS.

The communications device 2300 includes a processing system 2302 coupled to a transceiver 2308 (e.g., a transmitter and/or a receiver). The transceiver 2308 is configured to transmit and receive signals for the communications device 2300 via an antenna 2310, such as the various signals as described herein. The processing system 2302 may be configured to perform processing functions for the communications device 2300, including processing signals received and/or to be transmitted by the communications device 2300.

The processing system 2302 includes one or more processors 2320. In various aspects, one or more processors 2320 may be representative of one or more of receive processor 238, transmit processor 220, TX MIMO processor 230, and/or controller/processor 240, as described with respect to FIG. 2. The one or more processors 2320 are coupled to a computer-readable medium/memory 2330 via a bus 2306. In certain aspects, the computer-readable medium/memory 2330 is configured to store instructions (e.g., computer-executable code) that when executed by the one or more processors 2320, cause the one or more processors 2320 to perform one or more of the operations illustrated in FIG. 6 as well as the method 1800 and 2000 described with respect to FIG. 19, 21, or 22, or any aspects related to them. Note that reference to a processor of communications device 2300 performing a function may include one or more processors of communications device 2300 performing that function.

In the depicted example, the computer-readable medium/memory 2330 stores code (e.g., executable instructions) for transmitting 2331, code for receiving 2332, and code for obtaining 2333. Processing of the code 2331-2333 may cause the communications device 2300 to perform one or more of the operations illustrated in FIG. 6 as well as the method 1800 and 2000 described with respect to FIG. 19, 21, or 22, or any aspects related to them.

The one or more processors 2320 include circuitry configured to implement (e.g., execute) the code stored in the computer-readable medium/memory 2430, including circuitry for transmitting 2321, circuitry for receiving 2322, and circuitry for obtaining 2323. Processing with circuitry 2321-2323 may cause the communications device 2300 to perform one or more of the operations illustrated in FIG. 6 as well as the method 1800 and 2000 described with respect to FIG. 19, 21, or 22, or any aspects related to them.

Various components of the communications device 2400 may provide means for performing one or more of the operations illustrated in FIG. 6 as well as the method 1800 and 2000 described with respect to FIG. 19, 21, or 22, or any aspects related to them. Means for transmitting, sending or outputting for transmission may include the transceivers 232 and/or antenna(s) 234 of the BS 102 illustrated in FIG. 2 and/or transceiver 2308 and antenna 2310 of the communications device 2300 in FIG. 23. Means for receiving or obtaining may include the transceivers 232 and/or antenna(s) 234 of the BS 102 illustrated in FIG. 2 and/or transceiver 2308 and antenna 2310 of the communications device 2300 in FIG. 23.

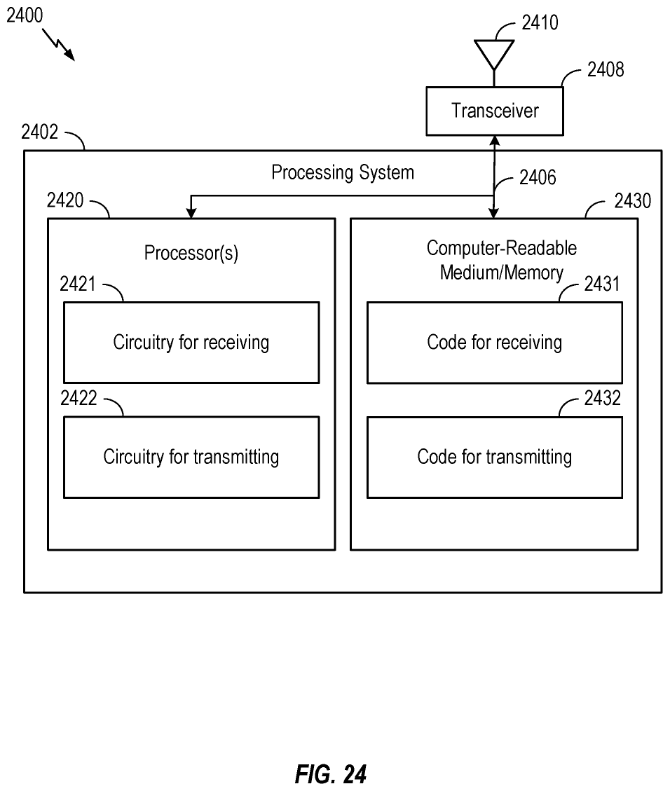

FIG. 24 depicts aspects of an example communications device 2400. In some aspects, communications device 2400 is a user equipment, such as UE 104 described above with respect to FIGS. 1 and 2.

The communications device 2400 includes a processing system 2402 coupled to a transceiver 2408 (e.g., a transmitter and/or a receiver). The transceiver 2408 is configured to transmit and receive signals for the communications device 2400 via an antenna 2410, such as the various signals as described herein. The processing system 2402 may be configured to perform processing functions for the communications device 2400, including processing signals received and/or to be transmitted by the communications device 2400.

The processing system 2402 includes one or more processors 2420. In various aspects, the one or more processors 2420 may be representative of one or more of receive processor 258, transmit processor 264, TX MIMO processor 266, and/or controller/processor 280, as described with respect to FIG. 2. The one or more processors 2420 are coupled to a computer-readable medium/memory 2430 via a bus 2406. In certain aspects, the computer-readable medium/memory 2430 is configured to store instructions (e.g., computer-executable code) that when executed by the one or more processors 2420, cause the one or more processors 2420 to perform one or more of the operations illustrated in FIG. 6 as well as the method 1800 and 2000 described with respect to FIGS. 18 and 20, or any aspects related to them. Note that reference to a processor performing a function of communications device 2400 may include one or more processors performing that function of communications device 2400.

In the depicted example, computer-readable medium/memory 2430 stores code (e.g., executable instructions) for receiving 2431 and code for transmitting 2432. Processing of the code 2431-2432 may cause the communications device 2400 to perform one or more of the operations illustrated in FIG. 6 as well as the method 1800 and 2000 described with respect to FIGS. 18 and 20, or any aspects related to them.

The one or more processors 2420 include circuitry configured to implement (e.g., execute) the code stored in the computer-readable medium/memory 2430, including circuitry for receiving 2421 and circuitry for transmitting 2422. Processing with circuitry 2421-2422 may cause the communications device 2400 to perform one or more of the operations illustrated in FIG. 6 as well as the method 1800 and 2000 described with respect to FIGS. 18 and 20, or any aspects related to them.

Various components of the communications device 2400 may provide means for performing one or more of the operations illustrated in FIG. 6 as well as the method 1800 and 2000 described with respect to FIGS. 18 and 20, or any aspects related to them. For example, means for transmitting, sending or outputting for transmission may include the transceivers 254 and/or antenna(s) 252 of the UE 104 illustrated in FIG. 2 and/or transceiver 2408 and antenna 2410 of the communications device 2400 in FIG. 24. Means for receiving or obtaining may include the transceivers 254 and/or antenna(s) 252 of the UE 104 illustrated in FIG. 2 and/or transceiver 2408 and antenna 2410 of the communications device 2400 in FIG. 24.

### Example Clauses

Implementation examples are described in the following numbered clauses:

Clause 1: A method for wireless communications by a user equipment (UE), comprising: receiving, from a network entity, a request for capability of the UE; and transmitting, in response to the request, a UE capability message that differentiates sets of features the UE supports in different network types.

Clause 2: The method of Clause 1, wherein the UE capability message differentiates a first set of features the UE supports in terrestrial networks (TNs) from a second set of features the UE supports in non-terrestrial network (NTNs).

Clause 3: The method of Clause 2, wherein the request includes a radio access technology (RAT) type that indicates NTNs as a separate RAT.

Clause 4: The method of any one of Clauses 2-3, wherein the UE capability message differentiates sets of features the UE supports in NTNs with different orbit types.

Clause 5: The method of Clause 4, wherein the different orbit types comprise two or more of: a low earth orbit (LEO) orbit type, medium earth orbit (MEO) orbit type, highly elliptical orbit (HEO) orbit type, geostationary (GEO) orbit type, or a non-GEO orbit type.

Clause 6: The method of any one of Clauses 4-5, wherein the UE capability message comprises: a first container indicating the first set of features the UE supports in TNs; and one or more second containers indicating the second set of features the UE supports in NTNs.

Clause 7: The method of Clause 6, wherein the one or more second containers comprise separate containers for NTNs with different orbit types.

Clause 8: The method of Clause 6, wherein the one or more second containers comprises a common container that differentiates sets of features the UE supports in NTNs with different orbit types.

Clause 9: The method of Clause 8, wherein the common container includes at least one of: separate bitmaps indicating different features supported in NTNs of different orbit types; separate capability fields for different orbit types; or a combination of at least one structure indicating a common set of features supported in different orbit types and separate structures indicating different features supported in NTNs of different orbit types.

Clause 10: The method of any one of Clauses 6-9, wherein the one or more second containers differentiate, for NTNs with different orbit types, UE support for features related to at least one of: physical layer processing; packet data convergence protocol (PDCP) processing; radio link control (RLC) processing; mobility; or IP Multimedia Subsystem (IMS).

Clause 11: The method of Clause 10, wherein: the first container and the one or more second containers indicate common features; and for a feature not applicable to NTNs, the UE indicates, in the one or more second containers, that the feature is not supported.

Clause 12: The method of any one of Clauses 2-5, wherein the UE capability message comprises a common container indicating: the first set of features the UE supports in TNs; and the second set of features the UE supports in NTNs.

Clause 13: The method of Clause 12, wherein: a common set of features in the common container apply to both TNs and NTNs networks by default; and the common container includes an extension that differentiates features supported in only one of TNs or NTNs.

Clause 14: The method of any one of Clauses 2-5, wherein the UE capability message comprises: a first container indicating the first set of features the UE supports in TNs and a first portion of the second set of features the UE supports in NTNs; and at least a second container indicating a second portion of the second set of features the UE supports in NTNs.

Clause 15: The method of Clause 14, wherein the second container is limited to differential UE capability compared to first container.

Clause 16: The method of any one of Clauses 2-5, wherein the second set of features indicates a set of TN and NTN band combinations in which the UE supports at least one of carrier aggregation or dual connectivity.

Clause 17: The method of Clause 16, wherein the UE capability message comprises at least one of: a container that includes TN and NTN band combination for different NTN orbit types; or one or more orbit-specific containers, each indicating TN and NTN band combinations for a corresponding NTN orbit.

Clause 18. The method of any one of Clauses 16-17, wherein the UE capability message implicitly indicates an orbit associated with a band of a band combination via at least one of: a band defined for NTN per orbit type, a band combination set defined per orbit type, or by repeating a same band number for different orbit types.

Clause 19: The method of any one of Clauses 16-17, wherein the UE capability message explicitly indicates an orbit associated with a band of a band combination.

Clause 20: The method of any one of Clauses 16-17, wherein the UE capability message indicates the UE supports features in a frequency band via at least one of: NTN specific band definitions; or an indication of an existing band and NTN support capability for that band.

Clause 21: The method of any one of Clauses 2-5, wherein: the second set of features indicates a set of TN and NTN band combinations in which the UE supports carrier aggregation; the UE capability message further differentiates a third set of features the UE supports in NTN terrestrial from the second set of features the UE supports in NTNs; the third set of features indicates a set of TN and NTN band combinations in which the UE supports dual connectivity; and the second set of features and the third set of features are included in separate containers in the UE capability message.

Clause 22: A method for wireless communications by a network entity, comprising: transmitting, to a user equipment (UE), a request for capability of the UE; and receiving, in response to the request, a UE capability message that differentiates sets of features the UE supports in different network types.

Clause 23: The method of Clause 22, wherein the UE capability message differentiates a first set of features the UE supports in terrestrial networks (TNs) from a second set of features the UE supports in non-terrestrial network (NTNs).

Clause 24: The method of Clause 23, wherein the request includes a radio access technology (RAT) type that indicates NTNs as a separate RAT.

Clause 25: The method of any one of Clauses 23-24, wherein the UE capability message differentiates sets of features the UE supports in NTNs with different orbit types.

Clause 26: The method of Clause 25, wherein the different orbit types comprise two or more of: a low earth orbit (LEO) orbit type, medium earth orbit (MEO) orbit type, highly elliptical orbit (HEO) orbit type, geostationary (GEO) orbit type, or a non-GEO orbit type.

Clause 27: The method of any one of Clauses 25-26, wherein the UE capability message comprises: a first container indicating the first set of features the UE supports in TNs; and one or more second containers indicating the second set of features the UE supports in NTNs.

Clause 28: The method of Clause 27, wherein the one or more second containers comprise separate containers for NTNs with different orbit types.

Clause 29: The method of Clause 27, wherein the one or more second containers comprises a common container that differentiates sets of features the UE supports in NTNs with different orbit types.

Clause 30: The method of Clause 29, wherein the common container includes at least one of: separate bitmaps indicating different features supported in NTNs of different orbit types; separate capability fields for different orbit types; or a combination of at least one structure indicating a common set of features supported in different orbit types and separate structures indicating different features supported in NTNs of different orbit types.

Clause 31: The method of any one of Clauses 27-30, wherein the one or more second containers differentiate, for NTNs with different orbit types, UE support for features related to at least one of: physical layer processing; packet data convergence protocol (PDCP) processing; radio link control (RLC) processing; mobility; or IP Multimedia Subsystem (IMS).

Clause 32: The method of Clause 31, wherein: the first container and the one or more second containers indicate common features; and for a feature not applicable to NTNs, the UE indicates, in the one or more second containers, that the feature is not supported.

Clause 33: The method of Clause 23, wherein the UE capability message comprises a common container indicating: the first set of features the UE supports in TNs; and the second set of features the UE supports in NTNs.

Clause 34: The method of Clause 33, wherein: a common set of features in the common container apply to both TNs and NTNs networks by default; and the common container includes an extension that differentiates features supported in only one of TNs or NTNs.

Clause 35: The method of Clause 23, wherein the UE capability message comprises: a first container indicating the first set of features the UE supports in TNs and a first portion of the second set of features the UE supports in NTNs; and at least a second container indicating a second portion of the second set of features the UE supports in NTNs.

Clause 36: The method of Clause 35, wherein the second container is limited to differential UE capability compared to first container.

Clause 37: The method of Clause 23, wherein the second set of features indicates a set of TN and NTN band combinations in which the UE supports at least one of carrier aggregation or dual connectivity.

Clause 38: The method of Clause 37, wherein the UE capability message comprises at least one of: a container that includes TN and NTN band combination for different NTN orbit types; or one or more orbit-specific containers, each indicating TN and NTN band combinations for a corresponding NTN orbit.

Clause 39: The method of any one of Clauses 37-38, wherein the UE capability message implicitly indicates an orbit associated with a band of a band combination via at least one of: a band defined for NTN per orbit type, a band combination set defined per orbit type, or by repeating a same band number for different orbit types.

Clause 40: The method of any one of Clauses 37-38, wherein the UE capability message explicitly indicates an orbit associated with a band of a band combination.

Clause 41: The method of any one of Clauses 37-40, wherein the UE capability message indicates the UE supports features in a frequency band via at least one of: NTN specific band definitions; or an indication of an existing band and NTN support capability for that band.

Clause 42: The method of Clause 23, wherein: the second set of features indicates a set of TN and NTN band combinations in which the UE supports carrier aggregation; the UE capability message further differentiates a third set of features the UE supports in NTN terrestrial from the second set of features the UE supports in NTNs; the third set of features indicates a set of TN and NTN band combinations in which the UE supports dual connectivity; and the second set of features and the third set of features are included in separate containers in the UE capability message.

Clause 43: A method for wireless communications by a user equipment (UE), comprising: generating a partial set of UE capability information; and transmitting the partial set of UE capability information to a network entity.

Clause 44: The method of Clause 43, wherein the partial set of UE capability information indicates sets of features the UE supports in different network types.

Clause 45: The method of Clause 44, wherein the partial set of UE capability information differentiates a first set of features the UE supports in terrestrial networks (TNs) from a second set of features the UE supports in non-terrestrial network (NTN).

Clause 46: The method of any one of Clauses 43-45, wherein the partial set of UE capability information relates to mobility of the UE and comprises at least one of: one or more supported radio access technologies (RATs); one or more supported core network (CN) types; one or more supported frequency bands; one or more supported subcarrier spacings (SCSs); or one or more supported bandwidths (BWs).

Clause 47: The method of any one of Clauses 43-46, wherein the partial set of UE capability information comprises at least one of: one or more supported measurement capabilities; one or more supported mobility capabilities; or one or more supported random access channel (RACH) capabilities.

Clause 48: The method of any one of Clauses 43-47, wherein the partial set of UE capability information comprises: a minimum set of UE capability information the UE is to report; and an additional set of UE capability information.

Clause 49: The method of any one of Clauses 43-48, further comprising receiving, from a network entity, a request for capability of the UE that indicates the request is for the partial set of UE capability information.

Clause 50: The method of any one of Clauses 43-49, wherein, for certain radio access technology (RAT) network types, the UE is configured to report the partial set of UE capability information unless a request for capability of the UE indicates the request is for a full set of UE capability information.

Clause 51: The method of any one of Clauses 43-50, further comprising receiving, from a network entity, a request for an additional set of UE capability information.

Clause 52: The method of Clause 51, wherein the additional set of UE capability information comprises UE capability information not included in the partial set of UE capability information.

Clause 53: The method of Clause 51, wherein the additional set of UE capability information comprises a full set of UE capability information including UE capability information included in the partial set of UE capability information.

Clause 54: The method of any one of Clauses 51-53, wherein the UE generates at least the additional set of UE capability information after receiving a request from a network entity.

Clause 55: The method of Clause 54, wherein the request is received in, or multiplexed with, a handover command.

Clause 56: The method of any one of Clauses 54-55, wherein the UE generates the additional set of UE capability information based on a type of network a target cell belongs.

Clause 57: The method of any one of Clauses 54-56, wherein the request is received in a radio resource control (RRC) reestablishment message, an RRC reconfiguration message, or an RRC resume message.

Clause 58: The method of any one of Clauses 51-57, wherein the UE generates the additional set of UE capability information after completion of a handover.

Clause 59: A method for wireless communications by a network entity, comprising: transmitting a request for a partial set of user equipment (UE) capability information from a UE; and receiving the partial set of UE capability information from the UE.

Clause 60: The method of Clause 59, wherein the partial set of UE capability information indicates sets of features the UE supports in different network types.

Clause 61: The method of Clause 60, wherein the partial set of UE capability information differentiates a first set of features the UE supports in terrestrial networks (TNs) from a second set of features the UE supports in non-terrestrial network (NTN).

Clause 62: The method of any one of Clauses 59-61, wherein the partial set of UE capability information relates to mobility of the UE and comprises at least one of: one or more supported radio access technologies (RATs); one or more supported core network (CN) types; one or more supported frequency bands; one or more supported subcarrier spacings (SCSs); or one or more supported bandwidths (BWs).

Clause 63: The method of any one of Clauses 59-62, wherein the partial set of UE capability information comprises at least one of: one or more supported measurement capabilities; one or more supported mobility capabilities; or one or more supported random access channel (RACH) capabilities.

Clause 64: The method of any one of Clauses 59-63, wherein the partial set of UE capability information comprises: a minimum set of UE capability information the UE is to report; and an additional set of UE capability information.

Clause 65: The method of any one of Clauses 59-64, further comprising: transmitting a handover command to the UE to hand over the UE from the network entity to another network entity; and transmitting, to the UE, another request for an additional set of UE capability information.

Clause 66: The method of Clause 65, wherein the other request is transmitted within the handover command or is multiplexed and transmitted with the handover command.

Clause 67: A method for wireless communications by a network entity, comprising: obtaining a partial set of user equipment (UE) capability information associated with a UE; and transmitting, to the UE, a request for an additional set of UE capability information.

Clause 68: The method of Clause 67, wherein the partial set of UE capability information indicates sets of features the UE supports in different network types.

Clause 69: The method of Clause 68, wherein the partial set of UE capability information differentiates a first set of features the UE supports in terrestrial networks (TNs) from a second set of features the UE supports in non-terrestrial network (NTN).

Clause 70: The method of any one of Clauses 67-69, wherein the partial set of UE capability information relates to mobility of the UE and comprises at least one of: one or more supported radio access technologies (RATs); one or more supported core network (CN) types; one or more supported frequency bands; one or more supported subcarrier spacings (SCSs); or one or more supported bandwidths (BWs).

Clause 71: The method of any one of Clauses 67-70, wherein the partial set of UE capability information comprises at least one of: one or more supported measurement capabilities; one or more supported mobility capabilities; or one or more supported random access channel (RACH) capabilities.

Clause 72: The method of any one of Clauses 67-71, wherein the partial set of UE capability information comprises: a minimum set of UE capability information the UE is to report; and an additional set of UE capability information.

Clause 73: The method of any one of Clauses 67-72, wherein the additional set of UE capability information comprises UE capability information not included in the partial set of UE capability information.

Clause 74: The method of any one of Clauses 67-72, wherein the additional set of UE capability information comprises a full set of UE capability information including UE capability information included in the partial set of UE capability information.

Clause 75: The method of any one of Clauses 67-74, wherein the request for the additional set of UE capability information is transmitted in, or multiplexed with, a handover command.

Clause 76: The method of any one of Clauses 67-75, wherein the request for the additional set of UE capability information is transmitted in a radio resource control (RRC) reestablishment message, an RRC reconfiguration message, or an RRC resume message.

Clause 77: The method of any one of Clauses 67-76, wherein the additional set of UE capability information is received after completion of a handover associated with the UE.

Clause 78: The method of any one of Clauses 67-77, wherein the partial set of UE capability information is received from another network entity.

Clause 79: An apparatus, comprising: a memory comprising executable instructions; and one or more processors configured to execute the executable instructions and cause the apparatus to perform a method in accordance with any one of Clauses 1-78.

Clause 80: An apparatus, comprising means for performing a method in accordance with any one of Clauses 1-78.

Clause 81: A non-transitory computer-readable medium comprising executable instructions that, when executed by one or more processors of an apparatus, cause the apparatus to perform a method in accordance with any one of Clauses 1-78.

Clause 82: A computer program product embodied on a computer-readable storage medium comprising code for performing a method in accordance with any one of Clauses 1-78.

### Additional Wireless Communication Network Considerations

The techniques and methods described herein may be used for various wireless communications networks. While aspects may be described herein using terminology commonly associated with 3G, 4G, and/or 5G wireless technologies, aspects of the present disclosure may likewise be applicable to other communication systems and standards not explicitly mentioned herein.

Returning to FIG. 1, various aspects of the present disclosure may be performed within the example wireless communication network 100.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

FIG. 1 depicts various example BSs 102, which may more generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and others. Each of BSs 102 may provide communication coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communication coverage for a macro cell (covering relatively large geographic area), a pico cell (covering relatively smaller geographic area, such as a sports stadium), a femto cell (relatively smaller geographic area (e.g., a home)), and/or other types of cells.

While BSs 102 are depicted in various aspects as unitary communication devices, BSs 102 may be implemented in various configurations. For example, one or more components of base station may be disaggregated, including a central unit (CU), one or more distributed units (DUs), one or more radio units (RUs), a radio unit (RU), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture.

Different BSs 102 within wireless communication network 100 may also be configured to support different radio access technologies, such as 3G, 4G, and 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communication network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz—6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communication links 120 between BSs 102 and, for example, UEs 104, may be through one or more carriers, which may have different bandwidths (e.g., 5, 10, 15, 20, 100, 400, and other MHz), and which may be aggregated in various aspects. Carriers may or may not be adjacent to each other. Allocation of carriers may be asymmetric with respect to DL and UL (e.g., more or fewer carriers may be allocated for DL than for UL).

Wireless communication network 100 further includes a Wi-Fi AP 150 in communication with Wi-Fi stations (STAs) 152 via communication links 154 in, for example, a 2.4 GHz and/or 5 GHz unlicensed frequency spectrum.

Certain UEs 104 may communicate with each other using device-to-device (D2D) communication link 158. D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172 in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

Returning to FIG. 2, various example components of a BS 102 and a UE 104 are depicted, which may be used to implement aspects of the present disclosure.

In regards to an example downlink transmission, BS 102 includes a transmit processor 220 that may receive data from a data source 212 and control information from a controller/processor 240. The control information may be for the physical broadcast channel (PBCH), physical control format indicator channel (PCFICH), physical HARQ indicator channel (PHICH), physical downlink control channel (PDCCH), group common PDCCH (GC PDCCH), and others. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

In order to receive the downlink transmission, UE 104 includes antennas 252a-252r that may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

In regards to an example uplink transmission, UE 104 further includes a transmit processor 264 that may receive and process data (e.g., for the PUSCH) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, and other aspects described herein.

In various aspects, UE 104 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and other aspects described herein.

In some aspects, a processor may be configured to perform various operations, such as those associated with the methods described herein, and transmit (output) to or receive (obtain) data from another interface that is configured to transmit or receive, respectively, the data.

As above, FIGS. 3A, 3B, 3C, and 3D depict various example aspects of data structures that may be used in wireless communication network 100 of FIG. 1.

Wireless communication systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 3B and 3D) into multiple orthogonal subcarriers. Each subcarrier may be modulated with data. Modulation symbols may be sent in the frequency domain with OFDM and in the time domain with SC-FDM.

A wireless communication frame structure may be frequency division duplex (FDD), in which for a particular set of subcarriers and subframes within the set of subcarriers are dedicated for either DL or UL. Wireless communication frame structures may also be time division duplex (TDD), in which for a particular set of subcarriers and subframes within the set of subcarriers are dedicated for both DL and UL.

In FIGS. 3A and 3C, the wireless communication frame structure is TDD where D is DL, U is UL, and X is flexible for use between DL/UL. UEs may be configured with the slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot configuration. Subframes may also include mini-slots, which generally have fewer symbols than an entire slot. Other wireless communication technologies may have a different frame structure and/or different channels.

Generally, the number of slots within a subframe is based on a slot configuration and a numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 3A, 3B, 3C, and 3D, a resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DMRS) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may also transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a user equipment (UE), comprising:
receiving, from a network entity, a request for capability of the UE; and
transmitting, in response to the request, a UE capability message that differentiates sets of features the UE supports in different network types.

2. The method of claim 1, wherein the UE capability message differentiates a first set of features the UE supports in terrestrial networks (TNs) from a second set of features the UE supports in non-terrestrial network (NTNs).

3. The method of claim 2, wherein the request includes a radio access technology (RAT) type that indicates NTNs as a separate RAT.

4. The method of claim 2, wherein the UE capability message differentiates sets of features the UE supports in NTNs with different orbit types.

5. The method of claim 4, wherein the different orbit types comprise two or more of:
a low earth orbit (LEO) orbit type, medium earth orbit (MEO) orbit type, highly elliptical orbit (HEO) orbit type, geostationary (GEO) orbit type, or a non-GEO orbit type.

6. The method of claim 2, wherein the UE capability message comprises:
a first container indicating the first set of features the UE supports in TNs; and
one or more second containers indicating the second set of features the UE supports in NTNs.

7. The method of claim 2, wherein the UE capability message comprises a common container indicating:
the first set of features the UE supports in TNs; and
the second set of features the UE supports in NTNs.

8. The method of claim 7, wherein:
a common set of features in the common container apply to both TNs and NTNs networks by default; and
the common container includes an extension that differentiates features supported in only one of TNs or NTNs.

9. The method of claim 2, wherein the UE capability message comprises:
a first container indicating the first set of features the UE supports in TNs and a first portion of the second set of features the UE supports in NTNs; and
at least a second container indicating a second portion of the second set of features the UE supports in NTNs.

10. The method of claim 9, wherein the second container is limited to differential UE capability compared to first container.

11. The method of claim 2, wherein the second set of features indicates a set of TN and NTN band combinations in which the UE supports at least one of carrier aggregation or dual connectivity.

12. A method for wireless communications by a network entity, comprising:
transmitting, to a user equipment (UE), a request for capability of the UE; and
receiving, in response to the request, a UE capability message that differentiates sets of features the UE supports in different network types.

13. The method of claim 12, wherein the UE capability message differentiates a first set of features the UE supports in terrestrial networks (TNs) from a second set of features the UE supports in non-terrestrial network (NTNs).

14. The method of claim 13, wherein the request includes a radio access technology (RAT) type that indicates NTNs as a separate RAT.

15. The method of claim 13, wherein the UE capability message differentiates sets of features the UE supports in NTNs with different orbit types.

16. The method of claim 15, wherein the different orbit types comprise two or more of:
a low earth orbit (LEO) orbit type, medium earth orbit (MEO) orbit type, highly elliptical orbit (HEO) orbit type, geostationary (GEO) orbit type, or a non-GEO orbit type.

17. The method of claim 13, wherein the UE capability message comprises:
a first container indicating the first set of features the UE supports in TNs; and
one or more second containers indicating the second set of features the UE supports in NTNs.

18. The method of claim 13, wherein the UE capability message comprises a common container indicating:
the first set of features the UE supports in TNs; and
the second set of features the UE supports in NTNs.

19. The method of claim 18, wherein:
a common set of features in the common container apply to both TNs and NTNs networks by default; and
the common container includes an extension that differentiates features supported in only one of TNs or NTNs.

20. The method of claim 13, wherein the UE capability message comprises:
a first container indicating the first set of features the UE supports in TNs and a first portion of the second set of features the UE supports in NTNs; and
at least a second container indicating a second portion of the second set of features the UE supports in NTNs.

21. The method of claim 20, wherein the second container is limited to differential UE capability compared to first container.

22. The method of claim 13, wherein the second set of features indicates a set of TN and NTN band combinations in which the UE supports at least one of carrier aggregation or dual connectivity.

23. A user equipment (UE), comprising:
a memory comprising executable instructions; and
one or more processors configured to execute the executable instructions and cause the UE to:
receive, from a network entity, a request for capability of the UE; and
transmit, in response to the request, a UE capability message that differentiates sets of features the UE supports in different network types.

24. A network entity, comprising:
a memory comprising executable instructions; and
one or more processors configured to execute the executable instructions and cause the network entity to:
transmit, to a user equipment (UE), a request for capability of the UE; and
receive, in response to the request, a UE capability message that differentiates sets of features the UE supports in different network types.
